(19) United States
(12) Patent Application Publication
(10) Pub. No.: US 2026/0347200 A1
(43) Pub. Date: Nov. 5, 2026

(54) LARGE SCALED MANUFACTURING PROCESSES FOR SILVER-MEDIATED CERIUM OXIDE NANOPARTICLES

(71) Applicant: Kismet Technologies Inc., Orlando, FL (US)

(72) Inventors: Christina Hartsell Drake, Winter Park, FL (US); Scott Hoos, Apollo Beach, FL (US); Christopher S. Coughlin, Winter Park, FL (US)

(21) Appl. No.: 19/486,585

(22) PCT Filed: Aug. 23, 2023
(86) PCT No.: PCT/US2023/030945

§ 371 Date: Nov. 21, 2025

Related U.S. Application Data
(60) Provisional application No. 63/468,825, filed on May 25, 2023.

(51) Int. Cl. C01F 17/235; B82Y 30/00; B82Y 40/00

(52) U.S. Cl. CPC C01F 17/235; B82Y 30/00; B82Y 40/00; C01P 2004/64

(57) ABSTRACT

A method for manufacturing silver-modified cerium oxide nanoparticles (AgCNP2). The method includes ageing un-aged cerium oxide nanoparticles in a solution with silver nitrate and uses an accelerant. The accelerant speeds up peroxy ligand conversion of cerium oxide nanoparticles having a predominant 3+ cerium charge and accelerates evolution of all, to 1 ppm or less of the limit of detection, ionized Ag to crystallize onto cerium oxide nanoparticles as a non-ionized stable metallic silver phase to form the AgCNP2. The accelerant can be low heat of 90°-115 °F applied to the solution only after crash-out of the solution that is without an ingredient that incudes wholly un-stabilized hydrogen peroxide; wholly un-stabilized hydrogen peroxide mixed in the solution prior to aging; low heat of 90°-115 °F applied to heat the solution that incudes wholly un-stabilized hydrogen peroxide; and a form factor (FF) ratio of a vessel of the closed system where the ageing takes place.

### BACKGROUND

Embodiments relate to large-scale manufacturing processes for silver-mediated cerium oxide nanoparticles.

The process for manufacturing metal-mediated cerium oxide nanoparticles requires an ageing process to produce bio-active particles. Some processes of ageing metal-mediated cerium oxide include placing a solution with the un-aged cerium oxide nanoparticles in a container and observing a color change in the solution. For example, the solution of the un-aged cerium oxide nanoparticles that is to be aged may have a yellow tint. At the end of an ageing process, the solution becomes clear. An ageing process can use ionized silver during the ageing time to evolve into a metallic silver phase on the ceria surface. However, the ageing process can be very slow and costly. As a consequence, the solution with some ionized silver is washed to remove the ionized silver.

### SUMMARY

Embodiments relate to large-scale manufacturing processes for silver-mediated cerium oxide nanoparticles in a closed system without washing the aged solution. The manufacturing processes use at least one accelerant to speed up peroxy ligand conversion of AgCNP2.

An aspect incudes a method for manufacturing silver-modified cerium oxide nanoparticles (AgCNP2). The method includes ageing in a closed system un-aged cerium oxide nanoparticles in a solution that includes silver nitrate and uses at least one accelerant. The at least one accelerant speeds up peroxy ligand conversion to cerium oxide having a predominant 3+ cerium charge and accelerates evolution of all, to 1 ppm or less of the limit of detection, ionized Ag to crystallize onto cerium oxide nanoparticles with a stable, non-ionized metallic silver phase to form the AgCNP2. The at least one accelerant is selected from the group consisting of: low heat of 90°-115 °F applied to the closed system to heat the solution only after crash-out of the solution that is without an ingredient that incudes wholly un-stabilized hydrogen peroxide; wholly un-stabilized hydrogen peroxide mixed in the solution prior to aging by the closed system; low heat of 90°-115 °F applied to the closed system to heat the solution that incudes wholly un-stabilized hydrogen peroxide; and a form factor (FF) ratio of a vessel of the closed system where the ageing takes place.

An aspect includes a formulation comprising an aqueous solution including silver-modified cerium oxide nanoparticles (AgCNP2) having a predominant 3+ surface charge and in a range of about 3-35 nanometers (nm) in size, wherein the aqueous solution including the AgCNP2 produced with a method that includes at least one accelerant that speeds up peroxy ligand conversion to form AgCNP2.

An aspect includes a therapeutic article of manufacture comprising a body having fibers treated with the formulation that includes a first composition comprising one or more of a polymeric binder, a dispersant, and a stabilizer and an aqueous solution that includes AgCNP2. The AgCNP2 produced with a method that includes at least one accelerant that speeds up peroxy ligand conversion of AgCNP2.

Another aspect includes a touch screen display comprising a touch screen layer stack having a plurality of layers that includes a top surface layer; and the formulation coating the top surface layer. The formulation comprising AgCNP2 having a predominantly 3+ cerium charge and in a range of about 3-30 nm in size and in an amount that is in a range of about 1 weight percentage of a mixture having a binder and the AgCNP2 wherein the AgCNP2 is produced using a method that includes an accelerant that speeds up peroxy ligand conversion to form AgCNP2.

### BRIEF DESCRIPTION OF THE SEVERAL VIEWS OF THE DRAWINGS

To easily identify the discussion of any particular element or act, the most significant digit or digits in a reference number refer to the FIGURE number in which that element is first introduced.

FIG. 1A illustrates a vessel in accordance with one embodiment.

FIG. 1B illustrates a first vessel filled with synthesizing solution and precipitates in accordance with one embodiment.

FIG. 1C illustrates a second vessel filled with synthesizing solution and particulates in accordance with one embodiment.

FIG. 2 illustrates a system for the peroxy ligand conversion to silver-mediated cerium oxide nanoparticles according to one embodiment.

FIG. 3A illustrates a first closed system in accordance with one embodiment.

FIG. 3B illustrates a second closed system in accordance with one embodiment.

FIG. 4A illustrates a method for manufacturing AgCNP2 with a predominant 3+ surface charge in accordance with one embodiment.

FIG. 4B illustrates a flowchart of a process for forming an initial solution of FIG. 4A in accordance with one embodiment.

FIGS. 5A-5G illustrate images of different phases of the solutions of the method of FIG. 4A without heating.

FIG. 5A illustrates an image of a solution of cerium nitrate hexahydrate, silver nitrate, and hydrogen peroxide in a container at day 1 in accordance with one embodiment.

FIG. 5B illustrates an image of the solution of FIG. 5A after 2-4 days in accordance with one embodiment.

FIG. 5C illustrates an image of the solution of FIG. 5A after 4-5 days in accordance with one embodiment.

FIG. 5D illustrates an image of the solution of FIG. 5A after 45-60 days in accordance with one embodiment.

FIG. 5E illustrates an image of the solution of FIG. 5A after 75-90 days in accordance with one embodiment.

FIG. 5F illustrates an image of the solution of FIG. 5A after 90-120 days in accordance with one embodiment.

FIG. 5G illustrates an image of the solution of FIG. 5A after 120 days in accordance with one embodiment.

FIG. 6A illustrates an image of an aged solution including non-ionizing silver in a container after 3 months using the method of FIG. 4A with heat in accordance with one embodiment.

FIG. 6B illustrates an image of an aged solution including non-ionizing silver after 7 months in a container using the original synthesis process.

FIGS. 7A, 7B and 7C illustrate images of Escherichia Coli (E. Coli) liquid tests based on the aged solution of FIG. 6A using 0.05 mg/mL of AgCNP2 in accordance with one embodiment.

FIGS. 7D, 7E and 7F illustrate images of E. Coli liquid tests based on the aged solution of FIG. 6A using 0.1 mg/mL AgCNP2 in accordance with one embodiment.

FIGS. 7G, 7H and 7I illustrate images of E. Coli liquid tests based on the aged solution of FIG. 6A using 0.2 mg/mL AgCNP2 in accordance with one embodiment.

FIGS. 8A, 8B and 8C illustrate images of E. Coli liquid tests based on the aged solution of FIG. 6B using 0.05 mg/mL of AgCNP2 in accordance with one embodiment.

FIGS. 8D, 8E and 8F illustrate images of E. Coli liquid tests based on the aged solution of FIG. 6B using 0.1 mg/mL AgCNP2 in accordance with one embodiment.

FIGS. 8G, 8H and 8I illustrate images of E. Coli liquid tests based on the aged solution of FIG. 6B using 0.2 mg/mL AgCNP2 in accordance with one embodiment.

FIG. 9 illustrates a graph of superoxide dismutase (SOD) Enzyme Mimetic Assay for 0.2 mg/mL of AgCNP2 in accordance with one embodiment.

FIG. 10 illustrates a flowchart of a prior art method for forming AgCNP2.

FIG. 11 illustrates a flowchart of a method for forming AgCNP2 with heat in accordance with one embodiment.

FIG. 12 illustrates a table of ageing time relative to solution amount and form factor metrics in accordance with one embodiment.

FIGS. 13A-13J illustrate images of different phases of the solutions of the method of FIG. 4A without heating.

FIG. 13A illustrates an image of a solution of cerium nitrate hexahydrate, silver nitrate and hydrogen peroxide in a container in accordance with one embodiment.

FIG. 13B-13D illustrate images of the solution of FIG. 13A in different volume containers, large, medium, and small, at the end of day 1 in accordance with one embodiment.

FIG. 13E-13G illustrate images of the solution of FIG. 13A in different volume containers, large, medium, and small, during day 3 in accordance with one embodiment.

FIG. 13H-13J illustrate images of the solution of FIG. 13A in different volume containers, large, medium, and small, during day 7 in accordance with one embodiment.

FIG. 14A illustrates a cross-sectional view of a touch screen in accordance with one embodiment.

FIG. 14B illustrates an aspect of the subject matter in accordance with one embodiment.

FIG. 15 illustrates a flowchart of a method for forming a touch screen display in accordance with one embodiment.

FIG. 16 illustrates a wound care article according to an embodiment.

FIG. 17 illustrates a wound care article according to an embodiment.

FIG. 18 illustrates a wound care article according to an embodiment.

FIG. 19 illustrates a wound healing article according to an embodiment.

FIG. 20 illustrates a wound healing article according to an embodiment.

FIG. 21 illustrates a wound healing article having a body with a three-ply structure according to an embodiment.

FIG. 22 illustrates a wound healing article having body with a two-ply structure according to an embodiment.

FIG. 23 illustrates a side view of a wound healing article with a face mask form factor according to an embodiment.

FIG. 24 illustrates a surface of an article coated with a coating composition in accordance with one embodiment.

FIG. 25A illustrates a toilet seat coated with a coating composition in accordance with one embodiment.

FIG. 25B illustrates a door with a door handle coated with a coating composition in accordance with one embodiment.

FIG. 26A illustrates furniture coated with a coating composition in accordance with one embodiment.

FIG. 26B illustrates fabric coated with a coating composition in accordance with one embodiment.

FIG. 26C illustrates an interior wall of a building coated with a coating composition and having a door and a window in accordance with one embodiment.

FIG. 27 illustrates a flowchart of a process for coating a surface in accordance with one embodiment.

FIG. 28A illustrates a subject tooth 2800 in a clean state.

FIG. 28B illustrates a subject tooth of FIG. 28A with a coating of dental resin composite including AgCNP2 coated on the tooth in accordance with one embodiment.

FIG. 29 illustrates a coated subject tooth of FIG. 28B in the mouth with bacteria.

FIG. 30 illustrates a coated subject tooth of FIG. 29 releasing directed hydrogen peroxide (H₂O₂) to degrade or destroy caries-causing bacteria in accordance with one embodiment.

FIG. 31 illustrates the coated subject tooth of FIG. 30 with the bacteria degraded or destroyed.

### DETAILED DESCRIPTION

The inventors have surprisingly determined that silver-modified cerium oxide nanoparticles (AgCNP2) with predominantly 3+ Ce, as described herein, can be manufactured using a process with at least one accelerant that speeds up the peroxy ligand conversion to nanoparticles. The accelerant aids in evolving metal, such that a stable metal (i.e., silver) evolves to a non-ionized metallic phase on the cerium oxide nanoparticles.

The inventors have surprisingly determined that silver-modified cerium oxide nanoparticles (AgCNP2), as described herein, can be manufactured using a process with at least one accelerant that speeds up the peroxy ligand conversion to nanoparticles. The at least one accelerant evolves silver, such as silver precipitates to a non-ionized silver metallic phase more rapidly than without the at least one accelerant.

The inventors have surprisingly determined that silver-modified cerium oxide nanoparticles (AgCNP2), as described herein, can be manufactured using a process with an accelerant that speeds up the peroxy ligand conversion to nanoparticles by effectuating quicker access to water or other processing aqueous solution, for example.

The inventors have surprisingly determined that AgCNP2, as described herein, can be manufactured using a process with an accelerant that speeds up the peroxy ligand conversion to nanoparticles by using low heat and specifically below the boiling point of water or other processing aqueous solution, for example.

The inventors have surprisingly determined that AgCNP2, as described herein, can be manufactured using a process with an accelerant that speeds up the peroxy ligand conversion to nanoparticles by using a vessel form factor with or without heat, the form factor that limits stacking and/or crowding of the crashed-out particulates to maximize the particulates' surface being in direct contact with the water or other processing aqueous solution.

The inventors have surprisingly determined that AgCNP2, as described herein, can be manufactured using a process with at least one accelerant that speeds up the peroxy ligand conversion to nanoparticles by using wholly un-stabilized hydrogen peroxide with or without heat.

The inventors have surprisingly determined that silver-modified cerium oxide nanoparticles (AgCNP2), as described herein, can be manufactured using a process with at least one accelerant that produces AgCNP2 nanoparticles with only stable non-ionizing silver on the nanoparticle surface in a single vessel without the need for removal from or repackaging of the final product of a colloidal solution of AgCNP2 nanoparticles, wherein the colloidal solution of AgCNP2 nanoparticles from the process has essentially all, to 1 ppm or less of the limit of detection, ionized silver evolved to metallic silver.

The inventors have surprisingly determined that AgCNP2, as described herein, can be manufactured using a process in a closed system with at least one accelerant that produces AgCNP2 nanoparticles with only non-ionizing silver resulting in a single vessel without the need for removal from or repackaging of the final product of a colloidal solution of AgCNP2 nanoparticles from the closed system, wherein the colloidal solution of AgCNP2 nanoparticles from the process has essentially all, to 1 ppm or less of the limit of detection, ionized silver consolidated into metallic silver and no longer present in solution.

The inventors have surprisingly determined that AgCNP2, as described herein, can be manufactured using a process with at least one accelerant that produces AgCNP2 nanoparticles with only non-ionizing silver. At least one accelerant is low heat of 90-115 °F (or 32.2-46 °C) to speed up the ageing process wherein the ageing process is completed when all, to 1 ppm or less of the limit of detection, ionized silver has been consolidated into metallic silver and no longer present in the solution.

The inventors have surprisingly determined that silver-modified cerium oxide nanoparticles (AgCNP2), as described herein, can be manufactured using the process the uses low heat of 90-115 °F (or 32.2-46 °C) over the aging period to speed up the ageing process by a factor of 6. High temperatures during the aging process have a negative effect on production of AgCNP2.

The inventors have surprisingly determined that AgCNP2, as described herein, can be manufactured using the process to rapidly evolve silver precipitates to a non-ionized metallic silver phase using very low heat as an accelerant.

The inventors have surprisingly determined that silver-modified cerium oxide nanoparticles (AgCNP2), as described herein, can be manufactured using the process that uses a vessel form factor as an accelerant that promotes a reduction in ageing time by a factor in the range of 3-60, depending on the vessel form factor used.

The inventors have surprisingly determined that silver-modified cerium oxide nanoparticles (AgCNP2), as described herein, can be manufactured using the process that uses a very low heating process as an accelerant to expedite the ageing process. However, the heating process, if done before particle crash-out, makes the process unviable when wholly un-stabilized hydrogen peroxide is not used as the source of hydrogen peroxide for the synthesis. Also, understanding the surface area to synthesis volume form factor (nanoparticle access to water to resuspend into solution) is another accelerant to aid in reducing aging time.

The inventors have surprisingly determined that silver-modified cerium oxide nanoparticles (AgCNP2), as described herein, can be manufactured using a process that was also not previously well understood where the end of the ageing process is after silver has evolved on the nanoparticle surface, not just at the end of particulate reprecipitation (when solution first goes clear).

The inventors have surprisingly determined that AgCNP2, as described herein, can be manufactured using the process to rapidly evolve silver precipitates on cerium oxide nanoparticles to eliminate remaining ionized silver for a solution forming the AgCNP2 without the need to wash the residual particles and remaining solution. The elimination of a washing step provides a more environmentally friendly process since added amounts of dH₂O or diH₂O used in washing can be eliminated. Additionally, the reduced cost of manufacturing AgCNP2 by the reduction in the amount of dH₂O or diH₂O used in the manufacturing process is also achieved by eliminating the need for discarding, processing, and/or handling of spent dH₂O or diH₂O that would have been added in a washing step to wash away remaining ionized silver, as the waste byproduct comprising dH₂O or diH₂O and ionized silver requires special handling that is very costly.

The inventors have surprisingly determined that AgCNP2 can be manufactured using a shortened process that does not require washing of residual particles and silver can rapidly evolve on to cerium oxide nanoparticles to eliminate the presence of remaining ionized silver in a shorter time period. The ability to shorten the manufacturing time to colloidal stability of the solution reduces the storage facility and climate control necessary to store the colloidal solution.

An initial (original) synthesis to produce a specialized form of Janus type metal (i.e., silver) mediated cerium oxide nanoparticles with predominantly 3+ Ce and super oxide dismutase (SOD) enzyme like behavior is described in WO2021222779A1, titled “Dispensable nanoparticle based composition for disinfection” which is incorporated herein by reference and ACS NANO, by Craig J. Neal, et al., titled “schemMetal-Mediated Nanoscale Cerium Oxide Inactivates Human Coronavirus and Rhinovirus by Surface Disruption,” copyright 2021 by American Chemical Society, and published Aug. 26, 2021.

The original synthesis to produce a tote cost approximately $1,080,140 to manufacture AgCNP2 with 1× concentration with a manufacturing time of 9-12 months. The original synthesis with 4× concentration cost approximately $4,320,411 and took over one year. The new synthesis described herein cost $400 and took 3 weeks to manufacture AgCNP2 at 1× concentration. The new synthesis described herein cost $1532 and took 5 weeks to manufacture AgCNP2 at 4× concentration. Table 1 provides a summary of the manufacturing differences between the original synthesis and the new synthesis.

TABLE 1
Manufacturing
for a 275

| Gallon Tote | Cost | Manufacturing Time | |
|---|---|---|---|
| Original | S1.025M | 9-12 | months |
| synthesis (1x | $17k chemicals | | |
| concentration) | $8K water | | |
| | $1M waste disposal | | |
| Original | S4.3M | >1 | year |

| | | |
|---|---|---|
| synthesis (4x | $67k chemicals | |
| concentration) | $30k water | |
| | $4.2M waste disposal | |
| New | S400 | 3 weeks (low temperature |
| synthesis (1x | Total for chemicals and | heated with wholly un- |
| concentration) | water | stabilized H2O2) |
| | No waste disposal cost | |
| New | S1.5k | 5 weeks (low temperature |
| synthesis (4x | Total for chemicals and | heated with wholly un- |
| concentration) | water | stabilized H2O2) |
| | No waste disposal cost | |

The inventor has surprisingly discovered a process to manufacture AgCNP2 without the need for washing process which produces a hazardous product requiring special waste disposal processes. The new processes described herein provides significant savings in money and water consumption, as well as eliminates the creation of a hazard material byproduct requiring waste disposal.

In the original synthesis the method for forming AgCNP2 includes about 109 mg of cerium nitrate hexahydrate (99.999% purity) dissolved in about 47.75 mL dH₂O in a 50 ml square glass bottom. Then, about 250 μL of 0.2 M aq. AgNO₃ (99% purity) is added to the cerium solution above with the solution vortexed for 2 minutes: Machine: Vortexer. Then, about 2 mL of 3% hydrogen peroxide (stock) is added quickly to the above solution followed by immediate vortexing for 2 minutes at highest rotation speed (in vortexer machine). This solution is stored in dark condition at room temperature with the bottle (50 mL square bottom glass) cap loose to allow for release of evolved gases; solutions are left to age in these conditions for up to 3 weeks (monitoring solution color change from yellow to clear) to create 50 ml total volume of the solution. Particles are then dialyzed against 2 liters of dH2O over 2 days, (dialysis tubing) with the water changed every 12 hours and stored in the same conditions as for ageing. This process only produced approximately 50 mL.

This new synthesis provides a very cost-effective solution for the manufacture of AgCNP2 with predominantly 3+ Ce for use in a variety of products.

### DEFINITIONS

Unless specifically stated or obvious from context, as used herein, the term “about” is understood as within a range of normal tolerance in the art, for example, within 2 standard deviations of the mean. “About” can be understood as within 30%, 25%, 20%, 15%, 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term “about.”

As used herein, the term accelerant causes evolution of all, to 1 ppm or less of the limit of detection, ionized silver (Ag) to crystallize onto cerium oxide nanoparticles as a non-ionized metallic silver phase at a quicker rate (less time to age) than a process that does not use the accelerant.

As used herein, the term closed system is a physical system that does not transfer matter in or out of the system during the aging process to evolve all (below the limit of detection) ionized silver (Ag) to crystallize onto cerium oxide nanoparticles. At the end of the aging process there is no waste byproduct that is greater than 1 ppm of ionized silver that requires removal or washing.

As used herein, the term AgCNP ingredient includes an aqueous solution that include AgCNP with 1 ppm or less of the limit of detection of ionized silver present.

As used herein, the term “composition” or “composite” as used herein refers to a product that includes ingredients such as one or more of chemical elements, diluent, binder, additive, or constituent in specified amounts, in addition to any product which results, whether directly or indirectly, from a combination of the ingredients in the specified amounts.

The term “prevention” or “preventing” of a disorder, disease, or condition as used herein refers to, in a statistical sample, a measurable or observable reduction in the occurrence of the disorder, disease or condition in the treated sample set being treated relative to an untreated control sample set, or delays the onset of one or more symptoms of the disorder, disease or condition relative to the untreated control sample set.

As used herein, the term “subject,” “individual” or “patient” refers to a human, a mammal, or an animal.

The term “therapeutically effective amount” as used herein refers to an amount of active compound or pharmaceutical agent that elicits the biological or medicinal response in a tissue, system, animal, or human that is being sought by a researcher, veterinarian, medical doctor, or other clinician. A therapeutically effective amount can be given in one or more administrations. The amount of a compound which constitutes a therapeutically effective amount will vary depending on the compound, the disorder and its severity, and the general health, age, sex, body weight and tolerance to drugs of the subject to be treated, but can be determined routinely by one of ordinary skill in the art.

The term “treating” or “treatment” as used herein covers the treatment of a disorder, disease or condition described herein, in a subject, and includes: (i) inhibiting development of a disorder, disease or condition; (ii) slowing progression of the disorder, disease or condition; (iii) inhibiting, relieving, or slowing progression of one or more symptoms of the disorder, disease or condition; and (iv) assisting with a body's naturally occurring processes to remineralize tooth material to further strengthen teeth against decay and sensitivity.

As used herein “all ionized silver removed” means that the ionized silver is removed to the ppm range (as a residual if not totally removed, i.e., hard to detect). Ionized silver can have a limit of detection (LOD) of 1 ppm. The term “all ionized silver removed” means the ionized silver is at or less than 1 ppm (i.e., below the LOD).

The term “silver-modified cerium oxide nanoparticles,” or “AgCNP2” as used herein refers to cerium oxide nanoparticles with predominantly 3+ Ce coated with or otherwise bound to an antimicrobial promoting metal such as silver. In an embodiment, the silver-associated cerium oxide nanoparticles with predominantly 3+ Ce comprise a particle size in the range of 3 nm-35 nm, with a preferred range from 10 nm-20 nm.

The AgCNP2, as described herein, is a NanoRAD ingredient.

The term “predominant 3+ surface charge” means that the [Ce3+]:[Ce4+] ratio on the surface of the cerium oxide nanoparticle is greater than 50%.

The term “predominant 3+ surface charge” means that the [Ce3+]:[Ce4+] ratio on the surface of the cerium oxide nanoparticle is greater than 50%. In a specific example, the [Ce3+]:[Ce4+] ratio is greater than 60%.

The term “crash-out” as used herein refers to a process where something precipitates out of solution and collects at the bottom of the solution.

Silver-mediated cerium oxide nanoparticles have a variety of applications from the treatment of epithelial tissue for wound healing, dental caries, ocular wounds, treatment of surfaces as a disinfectant, preparation of coatings for objects with high touch exposure and more.

The inventors have determined that the initial (original) synthesis requires a long ageing time that increased in ageing time with increasing synthesis volume. Additionally, the initial synthesis required a water intensive washing step at the end of the ageing period that required a considerable amount of water (8 L for 50 ml of synthesized solution) that must then be treated as hazardous waste post synthesis. The new synthesis eliminates washing of the AgCNP2 by using at least one accelerant to evolve all the silver, such as silver precipitates to a non-ionized stable metallic phase on the cerium oxide nanoparticles.

The embodiments described herein provide a new synthesis process that reduces the time and cost to produce these nanoparticles (i.e., AgCNP2) with predominantly 3+ Ce in bulk. The new synthesis process provides 1) an increase in concentration of reactants per unit volume, and 2) elimination of the end washing step using at least one of a heating step to decrease the ageing time, a vessel form factor for decreasing ageing time, and wholly un-stabilized hydrogen peroxide, 3) significant reduction in the ageing time of the batch.

These improvements of the new synthesis drastically decrease the ageing time and cost for creation of Janus type metal mediated cerium oxide nanoparticles with predominantly 3+ Ce and super oxide dismutase (SOD) enzyme mimetic behavior.

This new synthesis allows for large scale production of a unique Janus type silver mediated cerium oxide nanoparticle colloidal in a reduced amount of time.

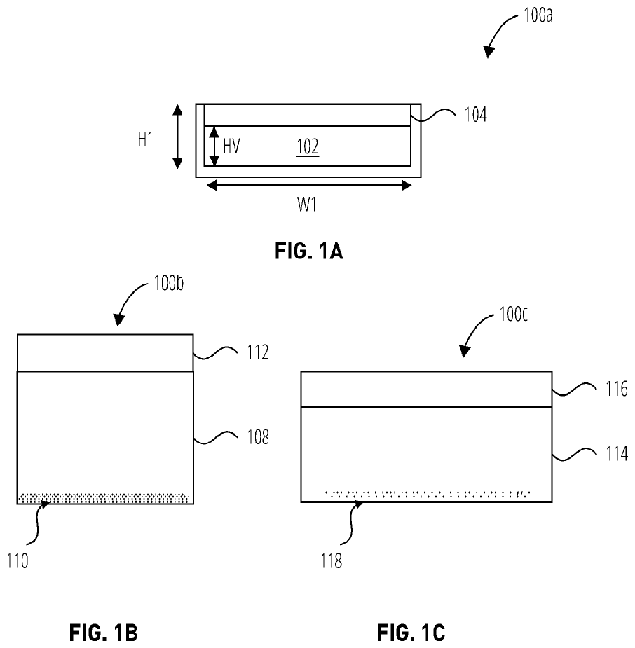

FIG. 1A illustrates a vessel 100a in accordance with one embodiment. The vessel 100a may be a first accelerant for use in a process with at least one accelerant that speeds up the peroxy ligand conversion to nanoparticles. The accelerant aids in evolution of metal, by increasing particulate access to water to more rapidly form cerium oxide, such that metal precipitates to a non-ionized stable metallic phase onto cerium oxide nanoparticles more rapidly, such as by a factor of 6, when compared to a process without a certain form factor. The vessel 100a with a surface area to synthesis volume form factor that increases the area of nanoparticles able to access water (or aqueous solution) to undergo crystallization to a colloid and resuspend into the solution.

The vessel 100a has an interior surface (IS) height H1 and an interior surface (IS) width W1. If the vessel 100 is round, the IS width W1 may be an inner diameter (ID). The vessel 100a has an IS height H1 that is smaller than the IS width W1 such that form factor (FF) ratio W1/H1>1. H1 describes the height on the volume of synthesis fluid in the container. For example, for the same vessel type, with a fixed height and diameter, decreasing the total reaction volume to a height in the vessel that achieves a ratio of W1/H1>1.

By way of non-limiting example, the vessel 100a may have an IS height H1 and IS width W1 which are equal. However, the height of the volume HV of solution should be less than IS width W1 so that the FF ratio is W1/HV>1.

By way of non-limiting example, the vessel 100a may have an IS height H1 that is larger than the IS width W1. However, the height of the volume HV of solution should be less than IS width W1 so that the FF ratio is W1/HV>1. This can be achieved by using about a third of the available height in the vessel, by example, so that the vessel becomes an accelerant.

In one example, the vessel is selected such that the FF ratio W1/HV is in the range of 0.20-0.50.

FIG. 1B illustrates a first vessel 100b filled with synthesizing solution and precipitates in accordance with one embodiment. FIG. 1C illustrates a second vessel 100c filled with synthesizing solution and precipitates in accordance with one embodiment.

FIG. 1B illustrates a first vessel 100b with a width/height <1. The first vessel 100b has an internal volume 112 with portion 108 filled with a synthesizing solution and crashed-out precipitates 110 collecting in the bottom of the internal volume 112. The width compared to the volume of the synthesizing solution causes stacking and crowding of the precipitates 110 which causes the surface-to-surface contact of adjacent and surrounding precipitates, reducing particulate access to water. The points of the precipitate's surface that are in direct surface-to-surface contact with other precipitates do not have immediate and/or direct access to the synthesizing solution. The inventors have determined that crowding of the precipitates 110 increases the ageing time because portions of the surface of particulates have limited access to the synthesizing solution, which delays the peroxy ligand conversion to silver-mediated cerium oxide nanoparticles as colloids in solution.

FIG. 1C illustrates the second vessel 100c with a width/height >1 to increase the concentration of reactants per unit volume for access by the precipitates. In FIG. 1C, the second vessel 100c has an internal volume 116 with portion 114 filled with a synthesizing solution and crashed-out precipitates 118 collecting in the bottom of the internal volume 116. The precipitates 118 are shown less crowded. Therefore, less portions of the surface of the precipitates 118 are in direct surface-to-surface contact with surrounding precipitates. As a consequence, the surface of the precipitates 118 compared to surface of precipitates 110 have an increase in access to the concentration of reactants per unit volume.

The form factor may be an important consideration especially for the manufacture of large volumes of silver-mediated cerium oxide nanoparticles, especially if a single vessel is used.

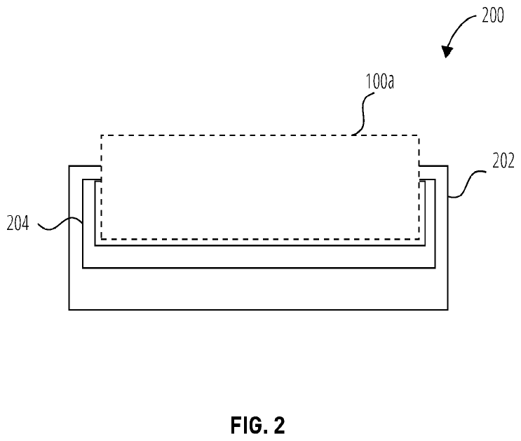

FIG. 2 illustrates a system 200 for the proxy ligand conversion to silver-mediated cerium oxide nanoparticles according to one embodiment. The system 200 may include vessel 100a and heating device 202. The bottom surface of vessel 100a may be in direct contact with the heating surface 204 of the heating device 202. The heat from the heating device 202 may be an accelerant to shorten the time for the peroxy ligand conversion to silver-mediated cerium oxide nanoparticles such that all the silver, such as silver precipitates evolve to a non-ionized metallic phase.

Both heating and the form factor of the vessel provide two accelerants to shorten the time for the peroxy ligand conversion to silver-mediated cerium oxide nanoparticles. The low heat applied to the vessel 100a allows ageing to take place in a shorter time period as compared to other processes. In an embodiment that uses wholly un-stabilized hydrogen peroxide the time is shortened as well and crash-out precipitates are not formed. In such an embodiment, the application of heat can be applied immediately to speed up the peroxy ligand conversion to nanoparticles.

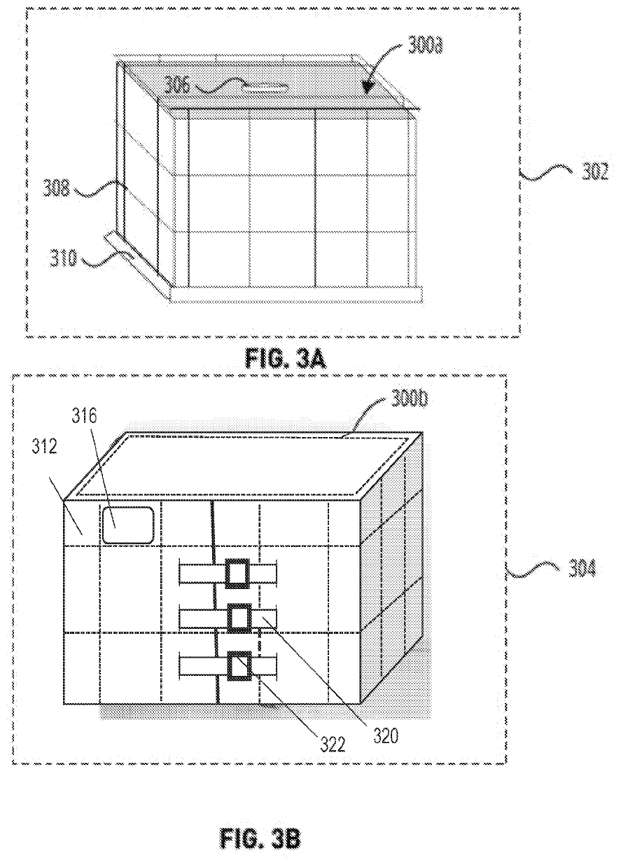

FIG. 3A illustrates a first closed system 302 in accordance with one embodiment. The first closed system 302 includes a vessel 300a. The vessel 300a is used as the container for mixing the solution to be aged. Once the ingredients are mixed, the vessel 300a is closed for the duration of the aging process and until the aging process has completed with no detectable (less than or equal to 1 ppm) ionized silver waste byproduct remains that requires removal. The closed system 302 may shorten the time for the peroxy ligand conversion to silver-mediated cerium oxide nanoparticles such that all the silver, such as silver precipitates, evolve to a non-ionized metallic phase with at least one accelerant being the form factor of the vessel 300a for use in the closed system. In another embodiment, an accelerant ingredient may be added to the solution, prior to forming the closed system.

The methods for manufacturing AgCNP2 with a predominant Ce 3+ charge is configured for closed system processing. A closed system minimizes introduction of contaminates since a single closed system vessel can be used throughout the manufacturing process to produce a volume of a colloidal composition of the manufactured AgCNP2 with a predominant Ce 3+ charge with all, to 1 ppm or less of the limit of detection, ionized silver removed through conversion to metallic silver. The new synthesis eliminates the need to wash or any other post processing steps after all the silver is evolved to a non-ionizing metallic phase. Washing of AgCNP2 can lead to a decrease in the predominance of Ce 3+ charge to Ce 4+.

In some embodiments, a colloidal composition of the manufactured AgCNP2 with a predominant Ce 3+ charge and all, to 1 ppm or less of the limit of detection, ionized silver removed through full conversion to metallic silver can be manufactured in a vessel that is for example 250+ gallons and subsequently, sold and distributed (transported) using the same closed system vessel. The vessel may be approved for food grade applications meeting the Food and Drug Administration (FDA) regulations. The vessel 300a may be made of polyethylene to hold a volume of fluid. The vessel 300a may be supported by a cage 308 and pallet 310 made of steel, aluminum, or other metal. The vessel may include an inlet 306, such as on top of the vessel, and an outlet (not shown).

An example vessel is an IBC tank with steel pallet, sold by ULINE, 12575 Uline Drive, Pleasant Prairie, WI, 53158. Another example vessel includes a 275 Gallon Rebottled IBC Tote that is sold by The Tank Depot, 658 John B Sias Memorial Parkway, Ste 330, Fort Worth, TX, 76134. Vessels of other sizes may be used that are smaller or larger than those described herein.

FIG. 3B illustrates a second closed system 304 in accordance with one embodiment. The second closed system 304 may include a vessel 300b, shown in dashed lines. The vessel 300b may be made of polyethylene configured to house a volume of a fluid or solution for the manufacture of AgCNP2 with a predominant Ce 3+ charge. The vessel 300b may be supported by a cage 312, shown in dashed line, which may be made of steel, aluminum, or other metal. The vessel 300b may include an inlet, such as on top of the vessel, and an outlet (not shown). The cage and pallet may be designed to allow for stacking vertically, in some examples, of the vessel 300b.

The second closed system 304 may also include a heating device 316. The heating device 316 may include an IBC tote heater configured to wrap around vertical side of the cage and vessel. The IBC tote heater may be sold by The Tank Depot, 658 John B Sias Memorial Parkway, Ste 330, Fort Worth, TX, 76134. Another example is Global Industrial® Insulated Tote Heating Blanket For 275 Gal IBC Tote, Up To 145 °F, 120V. The heating device 316 may include a heating jacket that wraps around the vessel 300b and includes straps 320 with fasteners 322. The heating device may include a control panel to control the heating temperature supplied by the heating device 316.

The vessel 300b is used as the container for mixing the solution to be aged. Once the ingredients are mixed, the vessel 300b is closed to form a closed system for the duration of the aging process and until no waste byproduct that is greater than 1 ppm of ionized silver remains. The closed system 302 shortens the time for the peroxy ligand conversion to silver-mediated cerium oxide nanoparticles such that all the silver, such as silver precipitates evolve to a non-ionized metallic phase with at least one accelerant. The accelerant may include the applied low heat created by the heating device 316 surrounding the closed system (i.e., vessel 300b) during the ageing process. The solution may be formed by adding a food grade hydrogen peroxide or a wholly un-stabilized hydrogen peroxide. In this instance, heat may be applied immediately by the having device 316 to the vessel of the closed system.

In some methods described herein below, the heating device 316 is applied after the precipitates crash-out of solution to the bottom of the synthesis volume. In one embodiment, the heat may be applied essentially immediately after all of the ingredients are added to the vessel to make the amount of solution.

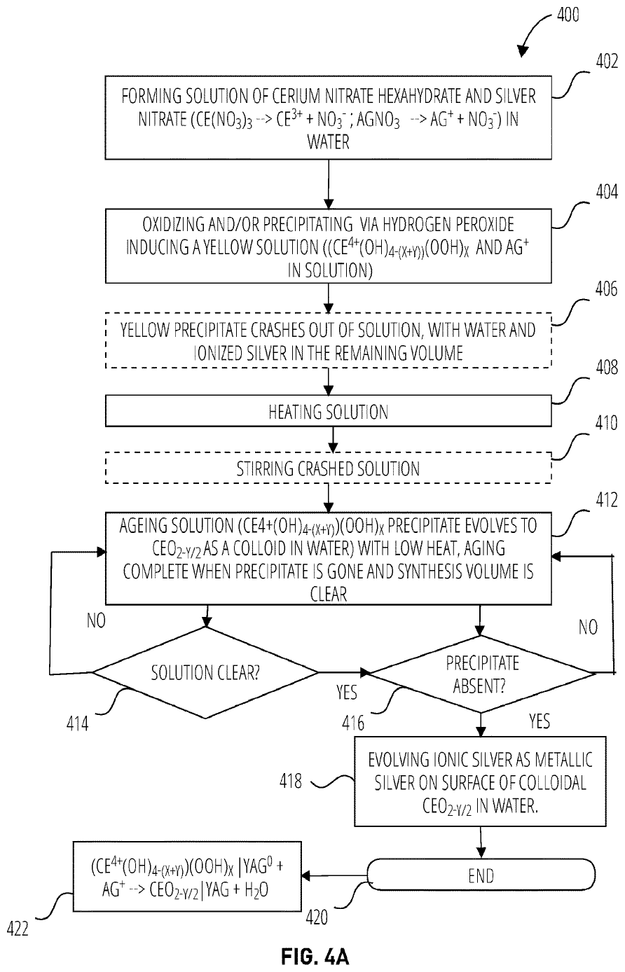

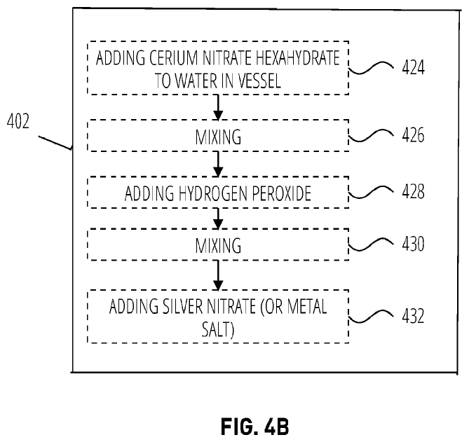

FIG. 4A illustrates a method 400 for manufacturing AgCNP2 with a predominant Ce 3+ charge in accordance with one embodiment. Although method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes forming an initial solution that may be comprised of cerium nitrate hexahydrate and silver nitrate (Ce(NO₃)₃→Ce³⁺+NO₃⁻; AgNO₃→Ag⁺+NO₃⁻) at block 402. The initial solution may form un-aged cerium oxide nanoparticles. By way of non-limiting example, after block 402, the system (vessel) may be closed such that no additional ingredients to the solution are added. However, a stirrer may be used to stir ingredients to homogenize the ingredients within the solution.

According to some examples, the method 400 includes oxidizing and precipitating via hydrogen peroxide inducing a yellow solution evolving as the initial cerium peroxy ligand is formed ((Ce⁴⁺(OH)_{4-(x+y)})(OOH)ₓ and Ag⁺ in synthesizing solution) at block 404. Full or brightest yellow color occurs within 12-24 hours of initial mixing, with the mixture initially starting clear and gradually attaining yellow color. According to some examples, the method 400 may include yellowing precipitate crashing out of solution, with water and ionized silver in the remaining volume at block 406. Block 406 is optional. Therefore, the block is represented in dashed lines.

According to some examples, the method 400 may include heating the solution in the vessel at block 408. The heating the solution is an accelerant that speeds up ageing by a factor of 3 or higher. According to some examples, the method 400 may include stirring the crashed solution at block 410, such as while it is being heated. The block 410 is denoted in a dashed line to denote that stirring is an optional in some embodiments. It should be understood that if the stirring is needed, it needs to be performed so that the solution crashes out. The heat is an accelerant and remains applied to the solution after the stirring may stop. However, after the full amount of the solution is created, the system is shut off to form a closed system.

In one example, when regular hydrogen peroxide is used, the solution is induced to yellow and then it crashes out and precipitates are formed. In another example, wholly un-stabilized hydrogen peroxide is used. In this example, the solution is induced to yellow with essentially no precipitates forms and no precipitate crash out occurs.

According to some examples, the method may include ageing solution (Ce⁴⁺(OH)_{4-(x+y)})(OOH)ₓ precipitate evolves to CeO_{2-y/2} as a colloid in water. This may take place with the low heat from the heating device (FIG. 2 or 3B) during block 408. Ageing is complete when precipitates are gone and/or synthesis volume is clear at block 412. At bock 412, in some examples, precipitates are not formed so a determination for determining whether precipitates are gone is eliminated or skipped.

According to some examples, the method 400 may include determining whether the solution is clear at decision block 414. If the determination is “NO,” the method returns to block 412 where ageing continues with heat. If the determination is “YES,” the method 400 includes determining whether precipitate is absent at decision block 416. If the determination is “NO,” the method returns to block 412. If the determination is “YES,” the method 400 has completed evolving ionic silver as metallic silver on surface of colloidal CeO_{2-y/2} in deionized water or synthesizing solution at block 418.

According to some examples, the method includes ending at block 420.

According to some examples, the resultant product includes (Ce⁴⁺(OH)_{4-(x+y)}) (OOH)ₓ|yAg⁰+Ag⁺→CeO_{2-y/2}|yAg+H₂O at block 422 and can remain in the same vessel used to age the solution where ionized silver is not greater than 1 ppm.

FIG. 4B illustrates a flowchart of a method 402 for forming an initial solution (at block 402) of FIG. 4A in accordance with one embodiment. FIG. 4B illustrates an example routine. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method 402 may include adding cerium nitrate hexahydrate to deionized water in the vessel at block 424. According to some examples, the method 402 may include mixing at block 426 to mix the cerium nitrate hexahydrate and the deionized water. To form the initial solution, deionized water needs to be added to the vessel as the medium to form the solution. In general, the deionized water is added to the vessel first.

According to some examples, the method 402 may include adding hydrogen peroxide at block 428. According to some examples, the method includes mixing at block 430. In some embodiments, the hydrogen peroxide may be added to the vessel before adding cerium nitrate hexahydrate. The hydrogen peroxide at block 428 should have a concentration of 3-5%. If the hydrogen peroxide has a concentration greater than 5%, the hydrogen peroxide should be diluted before adding to the solution in the vessel. Still further, if hydrogen peroxide has a concentration greater than 5% it may be added as a first ingredient to the deionized water such that the concentration is automatically diluted by the amount of deionized water in the vessel. It is not recommended to add silver nitrate with hydrogen peroxide before cerium nitrate being added to the volume of solution.

According to some examples, the method 402 may include adding silver nitrate (or metal salt) at block 432 to form an initial solution. In some examples, the silver nitrate may be added, after block 402 of FIG. 4A. For example, the silver nitrate (or metal salt) may be added in block 402, after the solution yellows in block 404 or after the solution crashes out of block 406 when non-wholly un-stabilized hydrogen peroxide is used, where non-wholly un-stabilized hydrogen peroxide is not an accelerant.

In some embodiments, the use of food grade hydrogen peroxide in lieu of other types of hydrogen peroxide eliminates the need for stirring at block 410 in FIG. 4A. In other words, mixing and stirring is only needed to form the initial solution with the food grade hydrogen peroxide or wholly un-stabilized hydrogen peroxide used as an accelerant.

In some embodiments, stirring is needed with any method described herein that uses a non-food grade hydrogen peroxide or non-wholly un-stabilized hydrogen peroxide. While not wishing to be bound by theory, food grade hydrogen peroxide or wholly un-stabilized hydrogen peroxide induces a yellowing of the solution but does not cause precipitates to form that need to be stirred to allow the peroxy ligand to access water to from cerium oxide nanoparticles which promote the evolution of ionized silver to non-ionized (metallic) silver.

In some embodiments, when heating is used as an accelerant the heating is applied after the crash-out of the precipitates in methods that use non-food grade hydrogen peroxide or non-wholly un-stabilized hydrogen peroxide. As discussed previously, food grade hydrogen peroxide or wholly un-stabilized hydrogen peroxide induces a yellowing of the solution but does not cause precipitates to form. Therefore, if heat is used, there is no need for a delay and can be applied immediately.

In some embodiments, the selection of the vessel may be an accelerant so that the precipitates can have improved access to water of the solution to speed up the ageing process such that all, to 1 ppm or less of the limit of detection, ionizing silver evolves to a non-ionizing silver phase.

The formulation of cerium oxide nanoparticles is produced with surfaces modified by stable metallic silver nanophases. Materials characterization shows that the silver components in each formulation are unique from each other and decorate the ceria surface as a Janus-type two-phase construct. The average diameter of AgCNP2 is about 20 nm to 35 nm. The crystallite sizes are 3-5 nm, which can also be the particle size in some instances. In some methods the crystallites agglomerate together, so the particle size is larger.

For example, an AgCNP2 ingredient is a preferred form of AgCNP for high touch surfaces, including toilets, sinks, door handles, walls, faucets, hard surfaces, cages, etc.

Each synthesis further possesses unique mixed valency with AgCNP2 possessing a significantly greater fraction of Ce3+ states relative to Ce4+ over catalase mimetic AgCNP1. The distinct valence characters, along with incorporation of chemically active silver phases, lead to high catalytic activities for each formulation. AgCNP2 possesses high superoxide dismutase activity.

There are a variety of methods to synthesize nanoceria particles, including wet chemical, solvothermal, microemulsion, precipitation, hydrolysis and hydrothermal, such as described in S. Das, et al., “Cerium oxide nanoparticles: applications and prospects in nanomedicine,” Nanomedicine 8(9)(2013) 1483-1508 and C. Sun, et al. “Nanostructured ceria-based materials: synthesis, properties, and applications,” Energy & Environmental Science 5(9)(2012) 8475-8505, both of which are incorporated herein by reference. Based on the synthesis methodology employed, the size of these NPs varies broadly from 3-5 nm to over 100 nm, and the surface charge can vary from −57 mV to +45 mV.

Further, analysis demonstrates that silver incorporated in each formulation is substantially more stable to redox-mediated degradation than pure silver phases: promoting an increased lifetime in catalytic applications and low probability of ionization of the silver phase.

Use of AgCNP2 formulation in effecting antimicrobial properties showed specific activity in tests associated with bacteria with, among bacteria species tested, AgCNP2 showing substantial activity towards Staphylococcus mutans, such as Staphylococcus aureus.

Although the amount is not intended to be limiting, when used in methods of the invention, some preferred amounts of silver percentages associated with the AgCNP2 being about 8% to 15% or less.

In some embodiments, the AgCNP2 of the NanoRAD ingredient is produced via a method comprising dissolving cerium and silver precursor salts such as cerium and silver nitrates and oxidizing the dissolved cerium and silver precursor salts. The cerium precursor salts are dissolved prior to silver salt. The purity on cerium nitrate hexahydrate can be as low as 99.9% with the silver purity also at 99.9%.

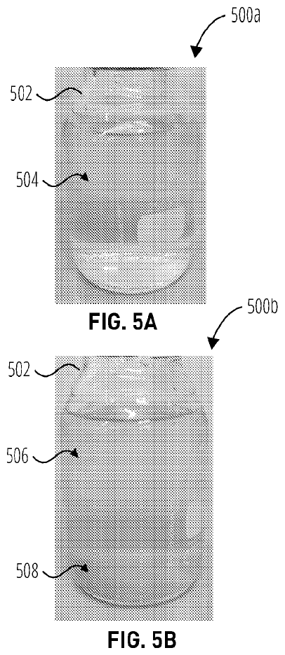

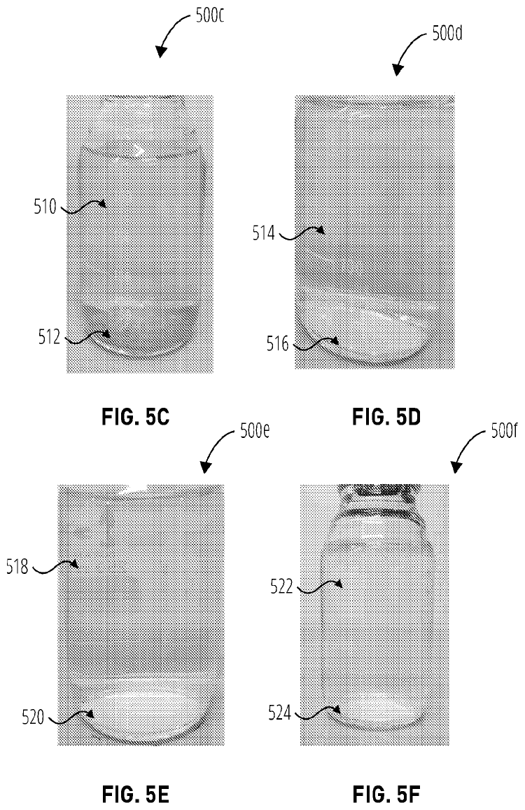

FIGS. 5A-5G illustrates images 500a, 500b, 500c, 500d, 500e, 500f and 500g of different phases of the solutions of the method 400 with heating at block 408. For the purposes of explanation, the container is a glass container that is transparent and holds 250 mL. This container in FIGS. 5A-5G is chosen so that the different changes to the solution can be seen. The methods herein are preferably used to make large volumes of AgCNP2 colloidal solution with concentration of 1×-8×.

Using a 275 gallon vessel, the solution at 1× concentration of 250 gallons of AgCNP2 includes:
960 L of deionized water (diH₂O);
2.18 kg (kilograms) of cerium nitrate hexahydrate;
169.87 g (grams) of silver nitrate; and
40 L of food grade hydrogen peroxide (H₂O₂) at 3% concentration.

These ratios hold for the different embodiments. In an embodiments for a 4× concentration of AgCNP2, the total fluid volume is held at 1000 L, but the cerium nitrate hexahydrate, silver nitrate, and hydrogen peroxide are increased by a factor of 4.

The process shown in FIGS. 5A-5G does not use an FF ratio for the vessel. In FIG. 5A-5G the at least one accelerant is low heat.

FIG. 5A illustrates an image 500a of a first solution 504 of cerium nitrate hexahydrate, silver nitrate, and hydrogen peroxide in a container in accordance with one embodiment. The image 500a is of the first solution at Day 1 in a container 502. The deionized water may be at 14 MΩ (Mega Ohms) and may be between 12-18 MΩ. The hydrogen peroxide may be in concentration from about 3% to about 35% or more and is diluted to 3%-5% with deionized water (diH₂O) when in concentrations greater than 5%. In this example, regular hydrogen peroxide was used, which causes precipitates to form in a crash-out phase.

FIG. 5B illustrates an image 500b of the yellowing of the solution 504 of FIG. 5A in a container in accordance with one embodiment. The yellow solution 506 is a batch appearance that turns to an orange yellow and begins to precipitate where the precipitates 508 sink to the bottom of container 302. The yellow solution 506 of image 500b occurs generally between Days 2-4. The yellowing precipitate 508 crashes out of the first solution 504, with water and ionized silver in the remaining volume of the solution 506.

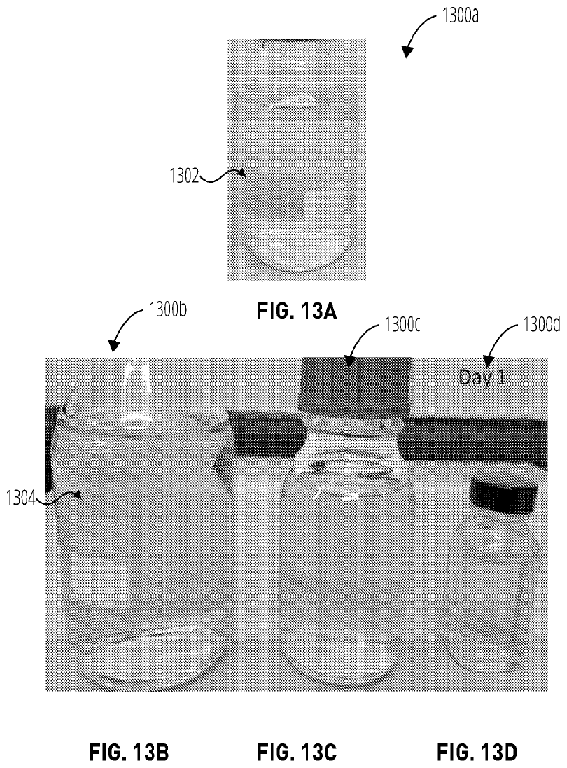

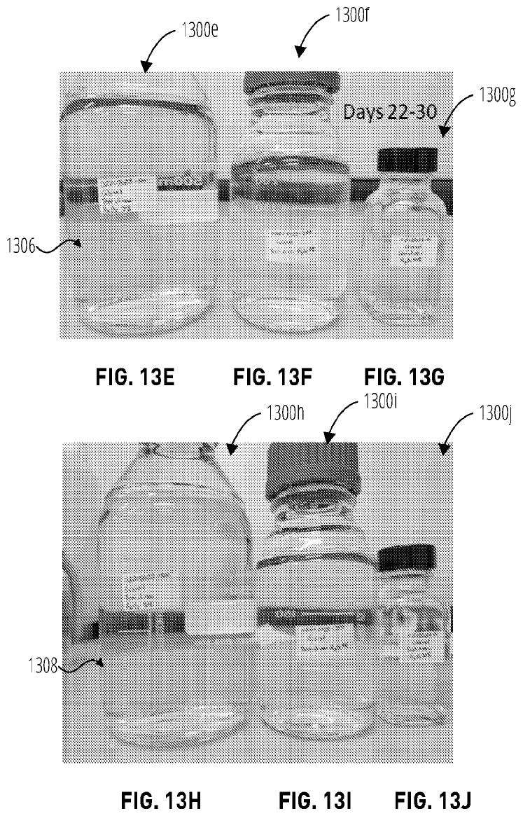

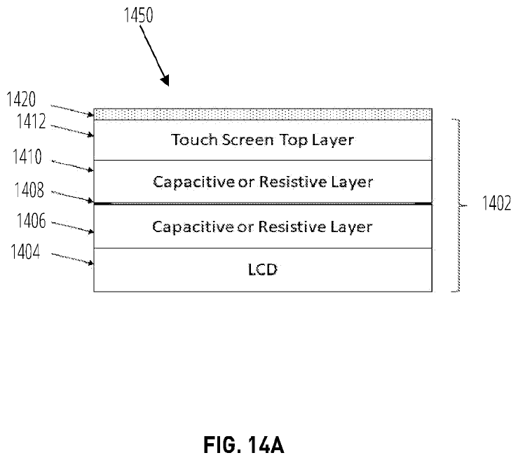

As will be discuses in FIGS. 13A-13J, when food grade or wholly un-stabilized hydrogen peroxide, no crashing precipitate occurs and instead, the reaction volume loses color over time, as will be described in relation to FIGS. 13A-13J.

FIG. 5C illustrates an image 500c of the solution of FIG. 5A after 4-5 days. The batch appearance of the solution 510 turns clear with an orange-yellow precipitate 512 settled on the bottom. Once the crash-out phase occurs the heat may be applied to the container/vessel to heat the solution in a closed system

FIG. 5D illustrates an image 500d of the solution of FIG. 5A after 45-60 days. The batch appearance of the solution 514 stays clear with most orange-yellow precipitate 516 re-precipitated as colloid, and about 10% remains settled.

FIG. 5E illustrates an image 500e of the solution of FIG. 5A after 75-90 days. The batch appearance of the solution 518 stays clear with most orange-yellow precipitate 520 re-precipitated as colloid, and about 5% remains settled. The settled precipitate 522 has a fuzzy appearance.

FIG. 5F illustrates an image 500f of the solution of FIG. 5A after 90-120 days. The batch appearance of the solution 522 stays clear with most orange-yellow precipitate 524 re-precipitated as colloid, and about 1-3% remains settled. The disturbed sediment has a smokey look when stirred into the fluid.

FIG. 5G illustrates an image 500g of the solution of FIG. 5A after 120 days. The batch appearance of the solution 526 is clear with no precipitate.

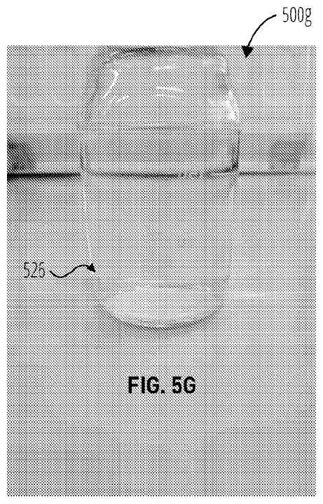

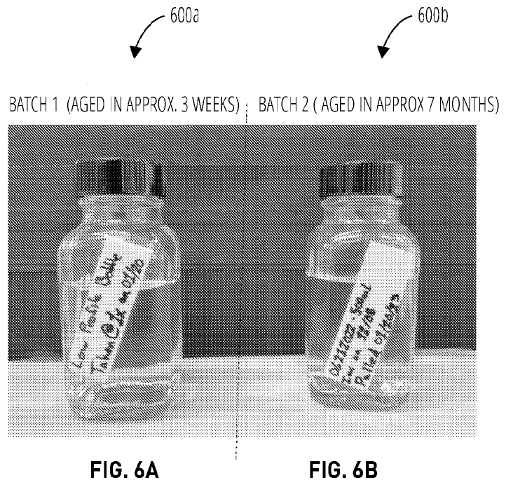

FIG. 6A illustrates an image 600a of an aged solution including non-ionizing and non-ionized silver in a container after 3 months using the method 400 of FIG. 4A in accordance with one embodiment. The method 400 used low heat at block 408 and generally continuously for 3 months, until the ageing process was complete.

FIG. 6B illustrates an image 600b of an aged solution including non-ionizing and non-ionized silver after 7 months in a container using the original synthesis method.

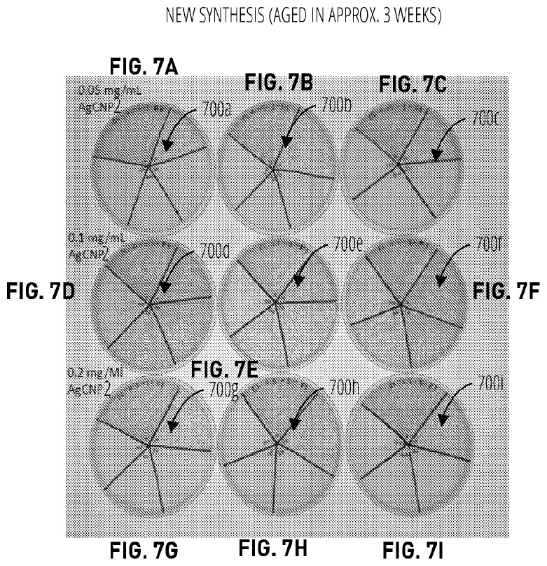

FIGS. 7A, 7B, and 7C illustrate images 700a, 700b and 700c of E. Coli liquid tests based on the aged solution of FIG. 6A using 0.05 mg/mL of AgCNP2 in accordance with one embodiment. The tests are for 0, 10, 30, 60 and 120 days.

FIGS. 7D, 7E, and 7F illustrate images 700d, 700e and 700f of E. Coli liquid tests based on the aged solution of FIG. 6A using 0.1 mg/mL AgCNP2 in accordance with one embodiment. The tests are for 0, 10, 30, 60 and 120 days.

FIGS. 7G, 7H, and 7I illustrate images 700g, 700h and 700i of E. Coli liquid tests based on the aged solution of FIG. 6A using 0.2 mg/mL AgCNP2 in accordance with one embodiment. The tests are for 0, 10, 30, 60 and 120 days.

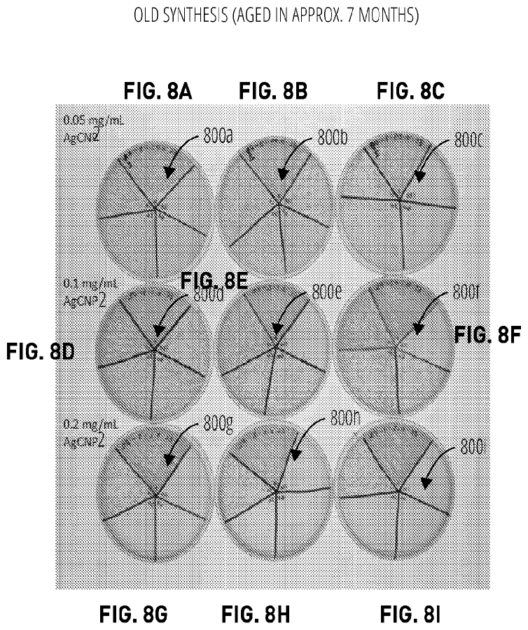

FIGS. 8A, 8B, and 8C illustrate images 800a, 800b and 800c of E. Coli liquid tests based on the aged solution of FIG. 6B using 0.05 mg/mL of AgCNP2 in accordance with one embodiment. The tests are for 0, 10, 30, 60 and 120 days.

FIGS. 8D, 8E, and 8F illustrate images 800d, 800e and 800f of E. Coli liquid tests based on the aged solution of FIG. 6B using 0.1 mg/mL AgCNP2 in accordance with one embodiment. The tests are for 0, 10, 30, 60 and 120 days.

FIGS. 8G, 8H, and 8I illustrate images 800g, 800h and 800i of E. Coli liquid tests based on the aged solution of FIG. 6B using 0.2 mg/mL AgCNP2 in accordance with one embodiment. The tests are for 0, 10, 30, 60 and 120 days.

FIGS. 7A-7I of the new synthesis and FIGS. 8A-8I of the original synthesis can be compared. It shows that the minimum inhibitory concentration and SOD activity are essentially unchanged between the two syntheses. In other words, the AgCNP2 manufactured by the new synthesis and the old synthesis have the SOD mimetic and inhibitory characteristics at essentially the same concentration.

The bottles of FIGS. 6A and 6B are volumes of fluid removed from the larger containers for the test. The same volume (500 ml) for the original synthesis or 10× the original synthesis in the WO2021222779A1 document. It can be seen that the aging time increased significantly from the 50 ml synthesis (6-8 weeks) to 7 months at room temperature.

The new synthesis is IL of AgCNP2 batch (20× the original synthesis) but this was done in a low profile container with dimensions of 10″ wide×15″0.5 high×2.75″ deep. The container was laid on its side so that the bottom area of the container was ~10″×15″ with a synthesis fill height of 1.5″ (total container height 2.75″) and finished aging at 3 weeks. The difference in ageing times is 3 weeks versus 7 months. The new process used heat as an accelerant at 95 °F after precipitate crashed out. The solution of the new synthesis aged in less than half the time at 20× the original synthesis volume. The container is from Hudson Exchange 5 Liter Hedpak Container with Cap, HDPE, Natural, 4 Pack available from Amazon.com.

The original synthesis used a cylindrical glass bottle (similar to original synthesis in terms of low surface area to volume), not heated. Aging time was nearly 4× the aging time at 50 ml.

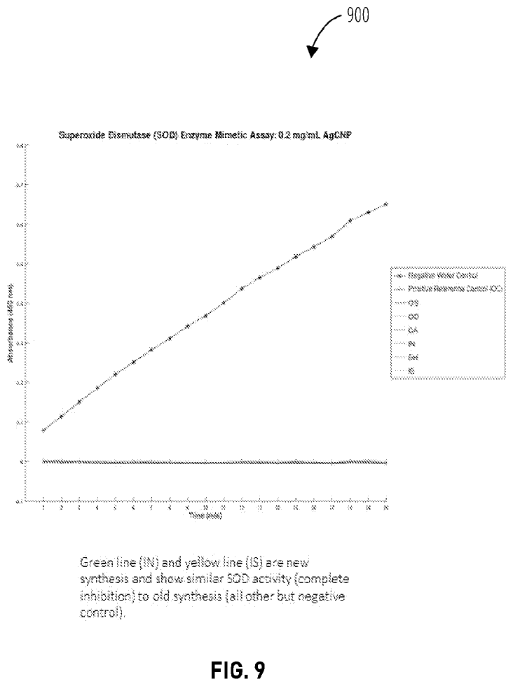

FIG. 9 illustrates a graph 900 of superoxide dismutase (SOD) Enzyme Mimetic Assay for 0.2 mg/mL of AgCNP2 in accordance with one embodiment.

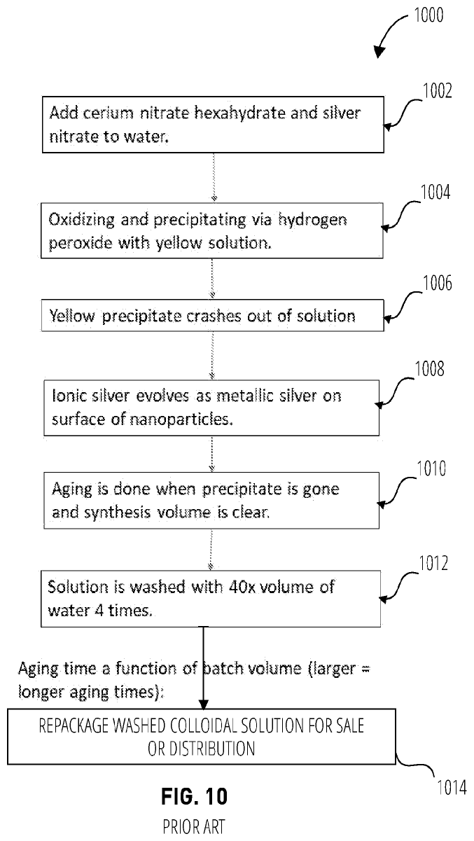

FIG. 10 illustrates a flowchart 1000 of a prior art method for forming AgCNP2. The method 1000 includes forming solution of cerium nitrate hexahydrate and silver nitrate (Ce(NO₃)₃→Ce³⁺+NO₃⁻; AgNO₃→Ag⁺+NO₃⁻) at block 1002.

According to some examples, the method 1000 includes oxidizing and precipitating via regular hydrogen peroxide which gradually changes the color of the solution from clear to yellow over a 12-24 hour period ((Ce⁴⁺(OH)_{4-(x+y)})(OOH)ₓ and Ag⁺ in synthesizing solution) at block 1004. The method 1000 includes yellowing precipitate crashing out of solution, with water and ionized silver in the remaining volume at block 1006.

The method 1000 includes evolving metallic silver onto the cerium oxide nanoparticles block 1008 and ageing when precipitate is gone and synthesis volume is clear at 1010, where the solution includes (Ce⁴⁺(OH)_{4-(x+y)})(OOH)ₓ|yAg⁰+Ag⁺→CeO_{2-y/2}|yAg+H₂O+Ag⁺. However, it was discovered that not all ionized silver has sufficiently evolved to non-ionizing metallic silver.

The method 1000 includes washing the aged solution with 40× volume of water 4 times at block 1012. In this process, a 50 mL volume is processed in 12-20 weeks and 1 L processed in 28-52 weeks. Inventors believe these different aging times are related to changes in storage temperatures experienced by different batches depending on where they were stored for aging. At block 1014, the washed colloidal solution with AgCNP2 is packaged for sale or distribution. At room temperature, the accelerated aging is not expected because room temperature is between 70-75 °F.

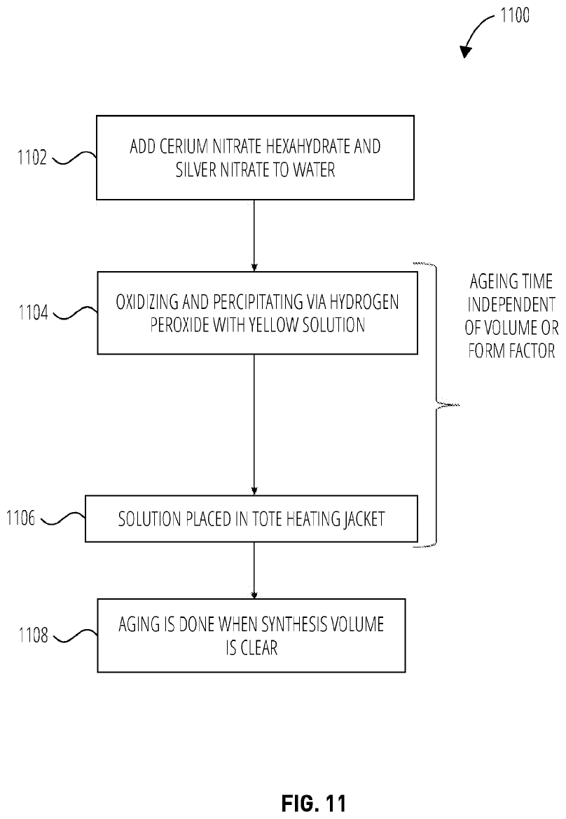

FIG. 11 illustrates a flowchart 1100 of a method for forming AgCNP2 with a predominant Ce 3+ charge using a heat application in accordance with one embodiment. Although the method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method 1100 includes forming a solution of cerium nitrate hexahydrate and silver nitrate in water at block 1102. In some embodiments, formed solution include deionized water (dH₂O), Ce(NO3)3.6H₂O, and AgNO₃ to the vessel. Light mixing may be applied to homogenize the batch solution.

According to some examples, the method 1100 includes oxidizing and precipitating via regular hydrogen peroxide inducing a yellow solution going from clear to yellow over a 12-24 hour period at block 1104. The H₂O₂ is wholly un-stabilized or food grade H₂O₂ and may be diluted with deionized water to 3%-5% when in concentrations greater than 5%. When forming the solution, the ingredients are mixed or stirred in the vessel. Light mixing may be applied to homogenize the batch solution.

The method 1100 also applies to a solution that is formed with wholly un-stabilized hydrogen peroxide. Depending on the order of forming the initial solution and whether the addition of the wholly un-stabilized or food grade H₂O₂ occurs first, the entry may be diluted by the deionized water in the initial solution. However, if the wholly un-stabilized or food grade H₂O₂ is added at any other time of forming the initial solution, then the wholly un-stabilized or food grade H₂O₂ needs to be diluted before being added to the vessel.

According to some examples, the method 1100 includes heating the solution at block 1106. The heating of the solution for the aging period speeds up ageing by factor 6. In some embodiments, the heating device such as the jacket shown in FIG. 3B is placed around the vessel to heat the solution to about 90°-115 °F.

According to some examples, the method 1100 includes ageing the solution while heat is applied. Ageing is complete when synthesis volume is clear at block 1108. The inventors have surprisingly determined that using food grade hydrogen peroxide or a wholly un-stabilized hydrogen peroxide can speed up the process in combination with heat application. In an embodiment, where food grade hydrogen peroxide or a wholly un-stabilized hydrogen peroxide is used in the solution, there is no delay needed in adding heat which speeds up the overall time for ageing as compared to the time to manufacture using regular hydrogen peroxide.

By way of non-limiting example, the manufactured volume is independent for aging, aging instead is dependent on concentration above original synthesis (1×) when wholly un-stabilized hydrogen peroxide is used. A solution with a concentration of 1×~21 days to age; a concentration of 4×~30 days to age; and a concentration of 8×~45 days to age. Aging time is correlated to concentration as opposed to synthesis volume.

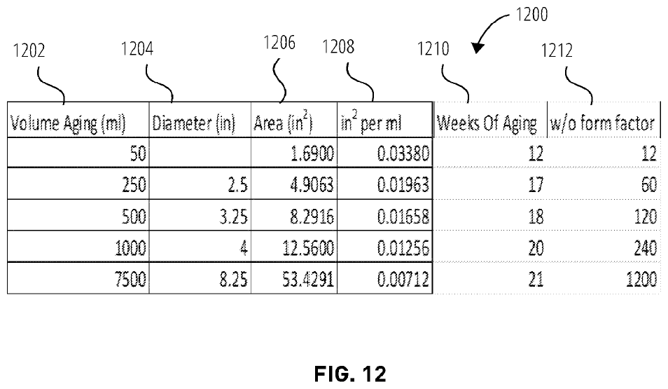

FIG. 12 illustrates a table 1200 of ageing time relative to solution amount and form factor ratio with heating to 95 °F in accordance with one embodiment. In this embodiment, the solution included regular hydrogen peroxide. The solution of FIG. 12 used regular hydrogen peroxide. The table 1200 includes a column 1202 for a volume aging (mL); column 1204, diameter of aging vessel (in); column 1206, Area of bottom surface of aging vessel (in²); column 1208, in² per mL; column 1210, weeks of ageing; and column 1212, without vessel form factor.

The ageing volumes (mL) include 50, 250, 500, 1000 and 7500. The diameter of the vessel for 250 mL was 2.5 in; 500 mL was 3.25 in; 1000 mL was 4 in; and 7500 mL was 8.25 in. The area was 1.690, 4.9063, 8.2916, 12.5600, and 53.4291. The in² per mL is 0.3380, 0.01963, 0.01658, 0.01256, and 0.00712.

The number of weeks for ageing volumes (mL) includes 12 for 50 mL, 17 for 250 mL, 18 for 500 mL, 20 for 1000 mL, and 21 for 7500 mL based on a form factor with W/H>1, for example. However, the ageing time was longer for larger batches of solution. For example, the weeks of aging volumes for 250 mL was 60 weeks; 500 mL was 120 weeks; 1000 mL was 240 weeks and 7500 mL was 1200 weeks of aging.

FIG. 13A illustrates an image 1300a of a solution 1302 of cerium nitrate hexahydrate, silver nitrate, and hydrogen peroxide in a container in accordance with one embodiment. The solution has a generally faint yellowish tint when the precursors and wholly un-stabilized hydrogen peroxide are initially mixed into the container.

FIGS. 13B-13D illustrate images 1300b, 1300c, and 1300d of the solution 1304 of FIG. 13A in different volume containers, large, medium, and small, at the end of day 1 in accordance with one embodiment. The solution 1304 in each container is at peak color for the synthesis as an orange-yellow with no readily detectable precipitation formed.

FIGS. 13E-13G illustrate an images 1300e, 1300f, and 1300g of the solution 1306 of FIG. 13A in different volume containers, large, medium, and small, 3 weeks into aging in accordance with one embodiment. The solution 1306 in each container has no readily detectable precipitation formed. The color of the solution has faded as colloids form with a faint yellowish tint.

FIG. 13H-13J illustrate an images 1300h, 1300i, and 1300j of the solution 1308 of FIG. 13A in different volume containers, large, medium, and small, 4 weeks into the aging process in accordance with one embodiment. The solution 1308 in each container has no readily detectable precipitation formed, and the solution is clear.

The images of FIGS. 13A-13J represent that the form factor of the vessel does not affect the acceleration of the ageing of the solution to evolve all, to 1 ppm or less of the limit of detection, ionizing silver to non-ionizing silver to complete the formation of AgCNP2 without the need to wash.

### Touch Screen Surface

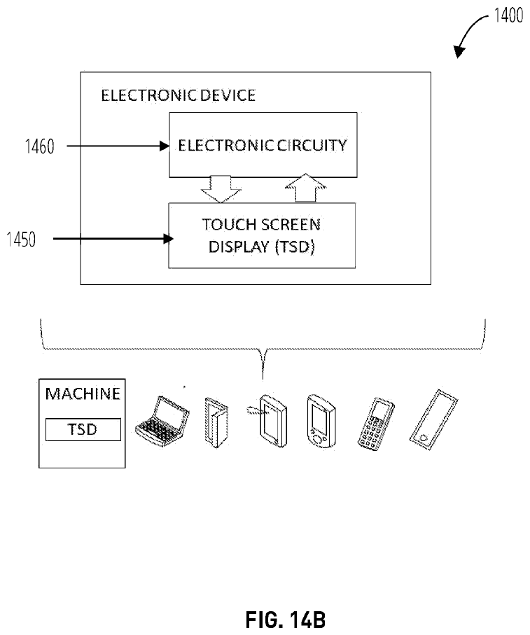

FIG. 14A illustrates a cross-sectional view of a touch screen 1450 in accordance with one embodiment. The touch screen 1450 may include a liquid crystal display (LCD) layer 1404. The LCD layer 1404 may include a liquid crystal cells sub-layer, for example. The LCD layer 1404 may include other sub-layers such as, without limitation, a plurality of sub-layers that include a fluorescent panel, polarization filter(s) and/or color filters (red, green, blue).

The touch screen 1450 may include a touch screen layer stack 1402 with one or more capacitive or resistive layers 1406 and 1410 above the LCD layer 1404, for example. The layer 1404 may include a plurality of layers. In this example, between layer 1406 and layer 1410, electrode layer 1408 may be provided. The capacitive or resistive layer(s) 1406, 1410 may include transparent conductive oxide (TCO) material made from ITO, ATO, or a conductive clear polymer. An example, touch screen is described in U.S. Pat. No. 8,400,408, entitled “Touch Screens with Transparent Conductive Material Resistors,” assigned to Apple Inc., which is incorporated herein by reference in entirety.

The transparent conductive oxide material is made from indium zinc oxide (IZO) or similar other transparent conductive oxides.

The touch screen layer stack 1402 may include a top layer 1412 on top of the one or more capacitive or resistive layers 1406 and 1410. In this example, the touch screen 1450 includes capacitive or resistive layer 1406 above the LCD layer 1404, electrode layer 1408 followed by a capacitive or resistive layer 1410. The touch screen layer stack 1402 includes a touch screen top layer 1412 above the capacitive or resistive layer 1410. Although the touch screen layer stack 1402 includes an LCD layer 1404, the LCD layer 1404 may be substituted with an LED layer that incorporates types of light-emitting diode technology or LCoS technology. For example, the LCD layer 1404 may be substituted with organic light-emitting elements.

Each layer of the touch screen may include sub-layers. Furthermore, the touch screen 1450 may include other layers not described herein based on the touch screen design.

The touch screen top layer 1412 may be a protective cover such that the capacitive or resistive layer(s) 1406 and 1410 are sandwiched between the top layer 1412 and the lower LCD layer 1404. The top layer 1412 may be made of glass or other transparent protective polymer.

Touch screen 1450 may include mutual-capacitive touch panels formed from rows and columns of traces on opposite sides of a dielectric. At the “intersections” of the traces, where the traces pass above and below each other (but do not make direct electrical contact with each other), the traces essentially form two electrodes with a mutual capacitance therebetween.

The touch screen 1450 may include a nanoparticle coating 1420, denoted with dotted hatching, having a coating composition of AgCNP2 having a predominantly 3+ cerium charge and a binder suitable for glass and which maintains transparency. The coating 1450 having the AgCNP2 (AgCNP in this application) may be bonded to the external side of the top layer 1452, where the AgCNP2 may be combined with a binder configured to cause nanoparticles to adhere to a glass surface or glass ceramic surface, such as a top layer of a touch screen surface, to coat the glass surface. The coating may have a thickness in the range of 0.55 to 1.8 millimeters (mm).

An example binder is described in U.S. Pat. No. 10,155,361, entitled “Method of Binding Nanoparticles to Glass,” assigned to Corning Incorporated, which is incorporated herein by reference in entirety.

The coating composition may include a dispersant additive to assist with AgCNP2 mixing. An example dispersant additive includes DISPERBYK-2081, manufactured by BYK-Chemie GmbH, Germany, or a solution of polycarboxylic acid salt. An example dispersant additive includes DISPERBYK-2019, manufactured by BYK-Chemie GmbH, Germany, or a solution of a copolymer with pigment-affinic groups. Recommended levels of the DISPERBYK-2019 additive are 20-60% for transparent iron oxides; 5-40% for inorganic pigments; and 6-8% for titanium dioxide. An example dispersant additive includes BORCHI Gen 1750, manufactured by Borchers, or high molecular weight, volatile organic compound (VOC) free wetting and dispersing agent. Recommended levels of the BORCHI Gen 1750 additive are 50-70% in a mixture including transparent iron oxide; 4-8% in a mixture including titanium dioxide. An example dispersant additive includes BORCHI Gen 12, manufactured by Borchers or low molecular weight non-ionic, alkyl phenol ethoxylates (APEO)- and VOC-free dispersant. Recommended levels of the BORCHI Gen 12 additive are 1-3% in an (oxide) based mixture including titanium dioxide.

The touch screen 1450 may include a support element such as glass, glass ceramic, or the like, a binder and a nanoparticulate layer of AgCNP2 to provide a nanotextured glass surface that has high durability and is ion exchangeable to impart mechanical strength as well as self-disinfecting properties.

The binder may include an alkali silicate, borate, or phosphate. In some embodiments, alkali silicate comprises SiO₂ and Alk₂O, wherein Alk comprises Li, Na or K at a ratio from about 0.05:1 to about 20.0:1 SiO₂:Alk₂O.

In some embodiments, alkali borate comprises R(HₙAlk₂O)·B₂O₃, n=0 to <2, wherein R is about 0.05 to about 20.0 and Alk comprises Li, Na or K at a ratio from about 0.05:1 to about 20.0:1 SiO₂:R(HₙAlk₂O)·B₂O₃.

In some embodiments, the binder comprises SiO₂ and HₙAlk₃₋ₙPO₄, wherein n=0 to <3 and Alk comprises Li, Na, or K, at a ratio from about 0.05:1 to about 20.0:1 SiO₂:HₙAlk₃₋ₙPO₄.

In some embodiments, the binder comprises SiO₂ at a weight percent from about 0.1 to about 40.0.

In some embodiments, the binder is heat-treated to remove water and to form a glass layer or coating.

The binder may be applied by dip coating, spin coating, slot coating, sputtering, DC magnetron sputtering, and various deposition processes. The deposition processes may include vapor deposition, chemical deposition, spray deposition, direct nanoparticle deposition, etc.

In some embodiments, the thickness of the binder comprises less than about one-quarter average diameter or one-half average diameter or the average diameter of said nanoparticles.

The binder may be a binder commonly used to incorporate nanoparticles into ITO such as polyvinyl pyrrolidone (PVP). The dispersant additive or binder themselves may be able to achieve good mixing and homogeneity separately or together but is based on the specific manufacturing technique.

Referring now to FIG. 14B, an electronic device 1400 or machine is provided that includes electronic circuitry 1460; and a touch screen user interface (e.g., touch screen display 1450) interfaced with the electronic circuitry, the touch screen user interface includes a top surface layer coated with a coating composition comprising silver-modified cerium oxide nanoparticles (AgCNP2) having a predominantly 3+ cerium surface charge and in a range of about 3-30 nm in size and in an amount that is in a range of 1 weight percentage of a mixture having a binder and the AgCNP2.

In view of the foregoing, the embodiments herein are directed to an electronic device with electronic circuitry and a touch-sensitive user interface including a touch screen surface having a top surface layer and a coating including a coating composition that includes silver-modified cerium oxide nanoparticles (AgCNP2) having a predominantly 3+ cerium surface charge and, as described herein, bonded to the top surface layer, the AgCNP2 being in the range of 3 nm to 30 nm.

In some embodiments, the touch screen surface may be integrated with stack layers of a liquid crystal display (LCD) or a light emitting diode (LED) display. The display may be an organic light-emitting diode (OLED) display, a quantum dot display (QLED, or a liquid crystal on silicon (LCoS) display.

In some embodiments, a touch screen display device is provided having a self-disinfecting top surface layer comprising a glass coated surface coated with a coating composition comprising silver-modified cerium oxide nanoparticles (AgCNP2) having a predominantly 3+ cerium charge and in a range of about 3-30 nm in size and in an amount that is in a range of 1 weight percentage of a mixture having a binder and the AgCNP2.

In some embodiments, a top surface layer of a touch screen 1450 is provided that is a self-disinfecting top surface layer comprising a glass coated surface coated with a coating composition comprising silver-modified cerium oxide nanoparticles (AgCNP2) having a predominantly 3+ cerium charge and in a range of about 3-30 nm in size and in an amount that is in a range of 1 weight percentage of a mixture having a binder and the AgCNP2.

In some embodiments, the binder may be applied to the glass surface to coat the surface by dip coating, spin coating, slot coating, sputtering, DC magnetron sputtering, or various deposition processes. The deposition processes may include vapor deposition, chemical deposition, spray deposition and direct nanoparticle deposition.

The silver in silver-modified cerium oxide nanoparticles of the coating composition may substitute a metal that may be an antimicrobial promoting metal that evolves to a non-ionizing and stable metal. The silver in silver-modified cerium oxide nanoparticles of the coating composition may substitute a metal that may be an antimicrobial promoting metal and a noble metal.

In some embodiments, the silver-modified cerium oxide nanoparticles comprise an AgCNP2 in an amount of about 1% by weight in the coating composition. The amount may be 0.05-0.99 weight %.

The silver-modified cerium oxide nanoparticles of the coating composition may comprise a predominantly Ce 3+ charge.

Moreover, the method may include forming a coating for a top surface layer of a touch screen, and/or a coating composition including the AgCNP2 in an amount of about 1% by weight in the coating composition where the AgCNP2 in the composition are in the range of about 3-30 nm in size. The amount may be about 0.05-0.99 weight %.

In some embodiments, the AgCNP2 of the coating composition for bonding to a touch screen is produced via a method comprising dissolving cerium and silver precursor salts such as cerium and silver nitrates and oxidizing the dissolved cerium and silver precursor salts.

In some embodiments, the AgCNP2 of the coating composition for bonding to a touch screen may be produced via a method comprising dissolving cerium and silver precursor salts such as cerium and silver nitrates; oxidizing the dissolved cerium and silver precursor salts via admixture with peroxide; and precipitating nanoparticles by subjecting the admixture with ammonium hydroxide.

In some embodiments, a method of disinfecting a touch screen surface includes coating the touch screen surface with a self-disinfecting nanoparticle coating composition including silver-modified cerium oxide nanoparticles (AgCNP2), as described herein, and a binder where the AgCNP2 in the coating composition are in the range of about 3-30 nm in size and about 1 weight percentage.

A touch screen display including a touch screen layer stack having a plurality of layers that includes a top surface layer; and a touch screen coating composition coating the top surface layer, the touch screen coating composition comprising silver-modified cerium oxide nanoparticles (AgCNP2) having a predominantly 3+ cerium charge and in a range of about 3-30 nm in size and in an amount that is in a range of about 1 weight percentage of a mixture having a binder and the AgCNP2 is non-ionizing.

The touch screen layer stack includes one of a liquid crystal display (LCD), a light emitting diode (LED) display, an organic light-emitting diode (OLED) display, a quantum dot display (QLED), and a liquid crystal on silicon (LCoS) display.

The binder includes one alkali silicate, borate, phosphate and polyvinyl pyrrolidone.

The binder includes alkali silicate that comprises SiO₂ and Alk₂O, wherein Alk comprises Li, Na or K at a ratio from about 0.05:1 to about 20.0:1 SiO₂:Alk₂O.

The touch screen layer stack includes resistive or capacitive elements below the top surface layer, the resistive or capacitive elements are made of one of indium tin oxide (ITO) and antimony tin oxide (ATO).

The coating composition is self-disinfecting surface that is optically transparent.

The coating composition further includes a dispersant additive including a copolymer with oxide-affinic groups or polymer non-ionic dispersing additive, and the binder includes polyvinyl pyrrolidone.

An electronic device includes electronic circuitry; and the touch screen display having a touch screen coating composition as described herein and interfaced with the electronic circuitry.

The touch screen display comprises one of a liquid crystal display (LCD), a light emitting diode (LED) display, an organic light-emitting diode (OLED) display, a quantum dot display (QLED) and a liquid crystal on silicon (LCoS) display.

The binder includes one alkali silicate, borate, phosphate and polyvinyl pyrrolidone.

The binder includes alkali silicate that comprises SiO₂ and Alk₂O, wherein Alk comprises Li, Na or K at a ratio from about 0.05:1 to about 20.0:1 SiO₂:Alk₂O.

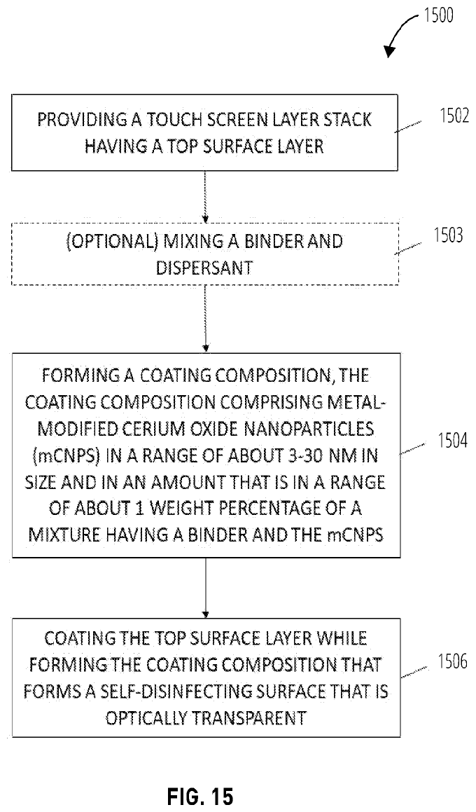

FIG. 15 illustrates a flowchart of a method 1500 for forming a touch screen display in accordance with one embodiment. The method 1500 of forming a touch screen display includes: providing the touch screen layer stack that includes a top surface layer; forming a touch screen coating composition, the touch screen coating composition comprising an aqueous solution that includes silver-modified cerium oxide nanoparticles (AgCNP2) having a predominantly 3+ cerium charge and in a range of about 3-30 nm in size and in an amount that is in a range of about 1 weight percentage of a mixture having binder and the aqueous solution with the AgCNP2 that is non-ionizing; and coating the top surface layer while forming the coating composition that forms a self-disinfecting surface that is optically transparent.

The mixture further comprises: a dispersant additive including a copolymer with oxide-affinic groups or polymer non-ionic dispersing additive, and the binder includes polyvinyl pyrrolidone; and the forming of the coating composition further comprises mixing the dispersant and the binder.

A touch screen coating composition for coating a top surface layer of glass, includes a binder; and silver-modified cerium oxide nanoparticles (AgCNP2) having a predominantly 3+ cerium charge and in a range of about 3-30 nm in size and in an amount that is in a range of about 1 weight percentage of a mixture having the binder and the AgCNP2 that is non-ionizing. The coating composition may include a dispersant additive including a copolymer with oxide-affinic groups or polymer non-ionic dispersing additive, and the binder includes polyvinyl pyrrolidone.

The method 1500 may be performed in the order shown or a different order. One or more of the blocks or steps may be performed contemporaneously. Additionally, one or more blocks or steps may be added or deleted.

The method 1500 may include, at 1502, providing a touch screen layer stack that includes a top surface layer. The method 1500 may include, at 1504, forming a coating composition, the coating composition comprising silver-modified cerium oxide nanoparticles (AgCNP2) having a predominantly 3+ cerium charge and in a range of about 3-30 nm or 3-35 nm in size and in an amount that is in a range of about 1 weight percentage of a mixture having a binder and the AgCNP2. In some embodiments, the AgCNP2 being mixed with a dispersant prior to fabrication into ITO/binder.

The mixture of the coating composition may have a dispersant additive, a binder, or dispersant additive and binder with the AgCNP2. The dispersant additive may include a copolymer with oxide-affinic groups or polymer non-ionic dispersing additive. The binder may include polyvinyl pyrrolidone (PVP).

The method 1500 may include, at 1506, coating the top surface layer while forming the coating composition that forms a self-disinfecting surface that is optically transparent.

### Wound Healing

Other uses of the AgCNP2 ingredient include use in the treatment of wound healing.

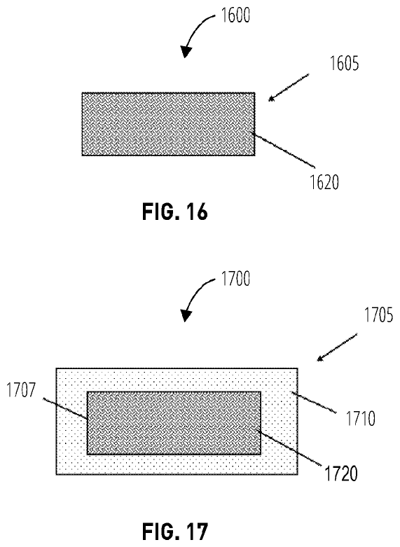

In some embodiments, treatments for wound healing may include applying a therapeutic dosage of wound healing composition to a fiber pad of a wound care article, described in relation to FIGS. 16-22 to form a wound healing article including both the wound care article and the therapeutic dosage of the wound healing composition.

In some embodiments, treatments for wound healing may include applying a therapeutic dosage of tissue glue, tissue adhesive, or surgical glue on the wound and covering or dressing a wound or surgical incision with a wound care article, described in relation to FIGS. 15-18.

As described herein, the wound care articles, wound healing articles, and articles incorporating treated fiber material treated with a solution including a mixture of 0.01 wt % of AgCNP2 ingredient and one or more of a binder, a dispersant, and a stabilizer, described herein, are a therapeutic article of manufacture. The AgCNP2 ingredient of the therapeutic article of manufacture includes AgCNP2 that have a predominant 3+ cerium charge, in a range of about 3-35 nanometers (nm) in size and includes a stable non-ionizing silver that has antimicrobial promoting properties.

The therapeutic article of manufacture includes treated fibers that eradicate bacteria, such as Streptococcus mutans and Staphylococcus aureus.

The therapeutic article of manufacture includes treated fibers that eradicate respiratory viruses, such as Rhinovirus 14, SARS-CoV-2 surrogate OC43 coronavirus and Parainfluenza virus type 5.

The therapeutic article of manufacture includes treated fibers that eradicate bacteria, such as Streptococcus mutans and Staphylococcus aureus, and viruses, such as Rhinovirus 14, SARS-CoV-2 surrogate OC43 coronavirus and Parainfluenza virus type 5.

The therapeutic article of manufacture includes treated fibers in a form factor designed as a barrier which can also treat a wound, incision or laceration formed in the epidermis or other anatomic tissue by preventing formation of bacteria, such as Streptococcus mutans and Staphylococcus aureus.

The therapeutic article of manufacture includes treated fibers in a form factor designed as a barrier which can protect the wearer from inhaled air from inspiration or inhalation that includes viruses, such as Rhinovirus 14, SARS-CoV-2 surrogate OC43 coronavirus and Parainfluenza virus type 5; and/or expiration particles that may include viruses, such as Rhinovirus 14, SARS-CoV-2 surrogate OC43 coronavirus and Parainfluenza virus type 5, trapped in the treated fibers.

The therapeutic article of manufacture includes treated fibers in a form factor designed as a barrier which can limit the spread of viruses, such as Rhinovirus 14, SARS-CoV-2 surrogate OC43 coronavirus and/or Parainfluenza virus type 5 upon expiration or exhalation of the wearer carrying such virus.

The therapeutic article of manufacture promotes wound healing and/or antimicrobial infection control.

FIG. 16 illustrates a wound care article 1600 according to an embodiment. The wound care article 1600 may include a body 1605 that includes a fiber pad with at least one layer or ply of material, denoted as numeral 1620. The material 1620 includes sterile fibers. The material fibers may be treated with a solution including a mixture of 0.01 wt % of AgCNP2 ingredient and one or more of a binder, a dispersant, and a stabilizer, wherein the AgCNP2 ingredient includes AgCNP2 that have a predominant 3+ cerium charge, a range of about 3-35 nanometers (nm) in size and only a stable non-ionizing metallic silver phase that has antimicrobial promoting properties. The wound care article 1600 may be a single-ply gauze material, a gauze pad, or a gauze sponge. The gauze pad may have multiple plies of gauze material.

A wound healing article may include a body having fibers treated with a mixture including a polymeric binder with silver-modified cerium oxide nanoparticles (AgCNP2) having a predominantly 3+ cerium charge. The AgCNP2 may be further mixed with a dispersant and/or stabilizer to promote adhesion with the binder and/or fibers. In some embodiments, the fibers may be formed of the mixture. The AgCNP2 may be in a range of about 3-35 nanometers (nm) in size. The AgCNP2 may be mixed in an amount that is in a range of about 0.01 to 0.1 weight percentage of a mixture having the binder (or binder dispersant and/or stabilizer) and the aqueous solution including the AgCNP2 where silver is an antimicrobial promoting metal with only a stable metallic non-ionizing silver phase.

The polymeric binder may include a biocompatible polymer such as, without limitations, polyethylene glycol (PEG), poly(lactic-co-glycolic acid)(PLGA), PEG-PLGA copolymer, polycaprolactone (PCL), Polyvinylpyrrolidone (PVP), poly(2-ethyl-2-oxazoline)(PetOx) and polyurethane. The binder may include PetOx which has a CAS No. of 25805-17-8 and a molecular formula of [C₅H₉NO]n.

The dispersants and stabilizers may include, without limitation, a cellulose polymer, Bile acids sodium salt, cholic acid-deoxycholic acid sodium salt mixture, Alcohols, C12-14 secondary Ethoxylated Dodecyldimethylamine Oxide (DDAO), Polyethylene Glycol and a block copolymer surfactant. The dispersant and/or stabilizer promote adhesion with the binder and/or the fibers of the body.

The body 1605 may include a 4″×4″ 8-ply gauze sponge or pad, a 2″×2″ 4-ply gauze sponge or pad or a medical grade gauze sponge or pad. For example, the body 1605 may include an 8″×10″, 12″×12″ or 12″×16″ gauze sponge or pad for an abdomen for abdominal surgical incisions or lacerations. The body 1605 may include any number of layers (i.e., plies) and/or sizes for various parts of the anatomy. For example, the body 1605 may include 2-12 plies of cotton fiber material 1620. The body 1605 may be packaged individually in a sterile packing (not shown). The body 1605 may include a length of material that is rolled up or wound to form a bandage roll. The gauze material may be available in a variety of thread counts.

In some embodiments, the term “treated” may include drying or curing a sterile solution with 0.01 wt % of AgCNP2 ingredient, such as AgCNP2 in a range of about 3-35 nanometers (nm) in size, on the fibers of material 1620.

In some embodiments, the fiber material 1620 may be a blend of material fibers. The fiber material may include one or more of polymers, yarns, cotton, and synthetic polymer fibers. In some embodiments, the fiber material 1620 may include 100% cotton. The blend of material fibers may include spandex such that the material stretches and/or provides compression to the wound sight when the wound care article is wrapped around a wound. The fiber material 120 may include a moisture-wicking fibers. The fiber material 1620 may include a ply of woven fibers and a ply of non-woven fibers. The fiber material 1620 may be a non-adhesive material that includes non-adherent fibers that will not stick to a wound.

For example, the material may include a Celox™ gauze material with quick clotting properties.

The wound care article 1600 may be a sterile burn dressing. The material may be a gel-soaked medical-grade non-woven material. The wound care article 1600 or material 1620 may be First Aid Only FAE-3000 series, FAE-5000 series and FAE-7012 compliant. The wound care article 1600 may include hydrogel impregnated non-adherent gauze. The hydrogel impregnated non-adherent gauze provides a moist healing environment around the wound wherein the hydrogel (such as, without limitation, PEG or a PEG-PLGA copolymer) is mixed with 0.01 wt % of a AgCNP2 ingredient that has a predominant 3+ surface charge and in a range of about 3-35 nanometers (nm) in size and a stable non-ionizing metallic silver phase that has antimicrobial promoting properties.

In some embodiments, the treated fiber material 1620 may have a form factor of an ace bandage with elastic fibers. For example, the treated fiber material 1620 may be a sterile self-adherent wrap material. Self-adherent wrap material is made by 3M™ Company using a trademark COBAN.

In some embodiments, the treated fiber material 1620 compatible with FAE-7012 is used for the treatment of skin burns.

In some embodiments, the treated fiber material 1620 treated with a mixture having the AgCNP2 ingredient may have a form factor of STERI-STRIP, such as manufactured by 3M™ Company in Saint Paul, MN, or thin adhesive bandages made by other manufacturers that can be used to close a laceration that may or may not have sutures to hold the skin together.

In some embodiments, the treated fiber material 1620 treated with a mixture including the AgCNP2 ingredient may be integrated into an advanced dressing containing biological or naturally derived agents. In some embodiments, the treated fiber material 1620 treated with the AgCNP2 ingredient may be integrated into an advanced dressing containing biological or naturally derived agents.

The treated fiber material 1620 may have a face mask form factor to prevent or limit spreading a respiratory track illness or lung disease. The treated fiber material 1620 may have a face mask form factor for the treatment of a wound to a lung or respiratory track injury from a biological or chemical inhalation or disease. In this case, the fiber material 1620 is applied to cover the nostrils of the wearer's nose or mouth. If the wearer exhales a virus, the treated fiber material 1620 traps the virus to treat the virus, which eradicates the virus to prevent or limit the spread of the virus. The treated fiber material 1620 may also be used to prevent or limit the re-inhalation of the virus by the wearer or inhalation of the virus from the ambient air of the environment.

The treated fiber material 1620 may have a replaceable filter form factor configured to be inserted into a face mask or professional breathing protection devices for prevention of wounds or injury to the respiratory track or lungs from Rhinovirus 14, SARS-CoV-2 surrogate OC43 coronavirus and Parainfluenza virus type 5.

The treated fiber material 1620 may have N95 Respirator Mask form factor or KN95 Respirator Mask.

The treated fiber material may have a Respirator Mask form factor.

In some embodiments, the treated fiber material 1620 treated with a mixture with the AgCNP2 ingredient may be integrated into anti-inflammatory and analgesic dressing.

In some embodiments, the treated fiber material 1620 may include impregnated fibers with a wound healing composition described herein.

FIG. 17 illustrates a wound care article 1700 according to an embodiment. The wound care article 1700 may include a body 1705 having a first layer 1707 having a pad of fiber material 1720 treated with a solution including 0.01 wt % of AgCNP2 ingredient and one of or a combination of polymeric binder, a dispersant, and a stabilizer, the AgCNP2 of the AgCNP2 ingredient has a predominant 3+ cerium charge and in a range of about 3-35 nanometers (nm) in size and evolves to a stable non-ionizing silver metallic phase that has antimicrobial promoting properties. The first layer 1707 may include at least one layer or ply of a fiber material 1720 (i.e., fiber material 1620) or other fibers described above in relation to FIG. 16.

The wound care article 1700 may include a second layer 1710. The second layer 1710 is shown hatched with dots. The second layer 1710 may be a waterproof layer of material with a coating of low tactile adhesive or glue compatible for adhesion directly onto the surface of skin. The second layer 1710 may be a pressure sensitive adhesive layer that adheres to the skin by application of pressure to the low-tactile adhesive. The adhesive layer may be a high-grab/instant tack adhesive. The wound care article 1700 may be compatible with International Standardization Organization (ISO) 10993 for medical bandages.

The second layer 1710 may be an adhesive strip constructed from thin films (or other types of polymers) such as, without limitations, made from polyurethane or polyethylene, and provide high-grab/instant tack adhesive. The thin films may be such as manufactured by 3M™ Company in Stain Paul, MN.

In some embodiments, the treated fiber material 1720 treated with the AgCNP2 ingredient may have a form factor of gauze fibers incorporated into transparent thin films, such as in a 3M™ TAGADERM roll with a transparent film dressing, such as manufactured to 3M™ Company in Saint Paul, MN. An amount of 0.1 wt % of AgCNP2 may be incorporated directly into the adhesive layer of the dressing, in a similar fashion to incorporation into fibers.

In some embodiments, the second layer 1710 may include elastic fibers and with a length to surround a portion of the anatomy, such as a wrist, arm, leg, foot, abdomen, chest, and head. The elastic fibers may stretch to provide a compressive force around the body with the fiber pad of the first layer overlaying the wound or incision.

The second layer 1710 may be affixed to the first layer 1707 so that both the first layer 1707 and the second layer 1710 are applied essentially together to a wound and surrounding skin. Alternately, the second layer 1710 may be a separate distinct layer that can be individually applied over the first layer 1707 when treating a wound.

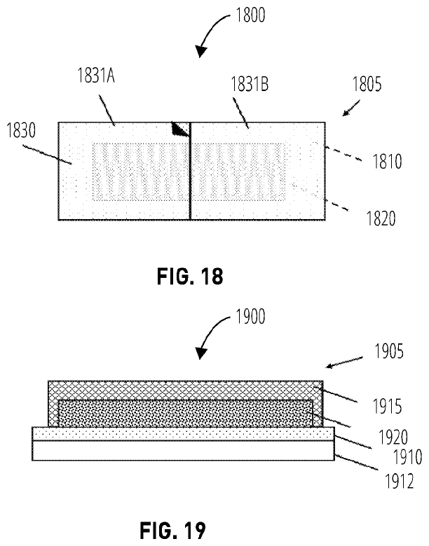

FIG. 18 illustrates a wound care article 1800 according to an embodiment. The wound care article 1800 may include a body 1805 having a fiber material 1820 (i.e., fiber material 1620) with a third layer 1830 comprising at least one peel-off liner 1831A, 1831B. In this example, the wound care article 1800 may include two peel-off liners 1831A, 1831B, which can be peeled away to expose the fiber material 1820 and the second layer 1810 including an adhesive strip. The third layer 1830 may overlay the treated fibers of the fiber pad and the low-tactile adhesive to protect the treated fibers and the low-tactile adhesive until use. The wound care articles 1600, 1700 and 1800 having a treated fiber pad that is treated with an amount of AgCNP2 may be used without a wound healing composition, an epithelial tissue healing agent, tissue glue, tissue adhesive, or surgical glue mixed with an amount of AgCNP2, described herein. The wound care articles 1600, 1700 and 1800 having a treated fiber pad may be used alone as a wound healing article to protect wounds or incisions from incubation of viruses or bacteria. The wound care articles 1600, 1700 and 1800 may be applied over surgical staples or medical stitches. The wound care articles 1600, 1700 and 1800 may be changed periodically and replaced with new wound care articles as part of a wound care healing treatment regime.

FIG. 19 illustrates a wound healing article 1900 according to an embodiment. The wound healing article 1900 may include a body 1905 having a waterproof layer 1912 with an adhesive layer 1910. The waterproof layer 1912 and the adhesive layer 1910 may include sublayers that are combined into a single layer. The layer 1910 may include a thin-film adhesive that includes a low-tactile adhesive material or high-grab/instant tack adhesive material. In some embodiments, the waterproof layer 1912 and adhesive layer 1910 may include a self-adherent wrap material. The wound healing article 1900 may include, in the body 1905, a matrix layer 1915 with open pores or a semipermeable membrane which are non-adherent materials. The matrix layer 1915 may comprise non-adherent material.

The waterproof layer 1912 has a first side that is intended to be exposed when in use. The waterproof layer 1912 includes a second side to which the adhesive layer 1910 is applied or incorporated.

The wound healing article 1900 may include, in the body 1905, a pad 1920 impregnated with or formed of a mixture or composite that includes an amount of a AgCNP2 ingredient that has a predominant 3+ cerium charge and in a range of about 3-35 nanometers (nm) in size and evolves to a stable non-ionizing metallic silver phase that has antimicrobial promoting properties. For example, the composite may include a mixture of the AgCNP2 ingredient and a therapeutic dosage of epithelial tissue healing agent or wound healing agent. For example, the composite may include a mixture of a hydrogel and the AgCNP2 ingredient which forms a therapeutic dosage of epithelial tissue healing composite. The pad 1920 may be surrounded by the matrix layer 1915. However, a portion extends beyond the perimeter edges of the waterproof layer 1912 and the adhesive layer 1910 so that enough surface area is exposed to adhesively bond the wound healing article 1900 to the skin of a patient.

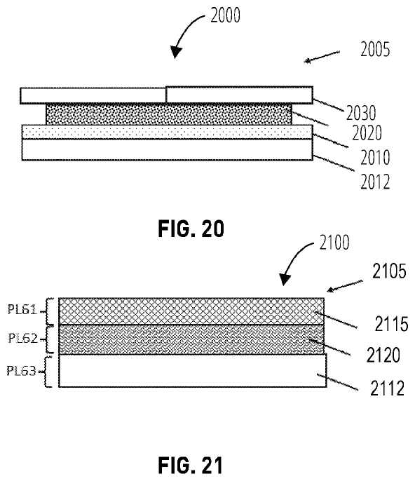

Wound healing article 1900 may include peel-off liners 2030 of FIG. 20.

Wound treatment may include applying the wound healing article 1900 to a wound by overlapping a wound or incision with the pad 1920 and applying pressure to the waterproof layer 1912 and the adhesive layer 1910. Additionally, applying slight pressure with a finger to the waterproof layer 1912 over the area of the pad 1920 causes a therapeutic dosage of epithelial tissue healing composite to pass through the open pores or the semipermeable membrane and onto the wound.

The non-adherent semipermeable membrane or non-adherent porous material of body 1905 on top of and surrounding the treated fibers is used to dispense the therapeutic dosage of epithelial tissue healing agent or the wound healing agent through the non-adherent semipermeable membrane or the non-adherent porous material.

FIG. 20 illustrates a wound healing article 2000 according to an embodiment. The wound healing article 2000 may include a body 2005 having a waterproof layer 2012 with an adhesive layer 2010. The waterproof layer 2012 and the adhesive layer 2010 may include sublayers that are combined into a single layer. The layer 2010 may include a low-tactile adhesive material or high-grab/instant tack adhesive material.

The wound healing article 2000 may include, in the body 2005, a pad 2020 impregnated with or formed of a mixture that includes an amount of AgCNP2 having a predominant 3+ cerium charge and in a range of about 3-35 nanometers (nm) in size and only a stable non-ionizing metallic silver phase that has antimicrobial promoting properties. The pad may include treated fibers that are impregnated with a healing wound composite. For example, the healing wound composite may include a mixture of the AgCNP2 ingredient and a therapeutic dosage of epithelial tissue healing agent.

The treated fibers may be impregnated fibers impregnated with or formed of a mixture including one or more of a binder, a dispersant, and a stabilizer; AgCNP2 that have a predominant 3+ cerium charge and in the range of about 3-35 nanometers (nm) in size; and a therapeutic dosage of epithelial tissue healing agent.

The wound healing article 2000 may include, in the body 2005, at least one liner 2030 to cover and protect the pad 2020 and or the mixture or composite.

In some embodiments, the bodies 1605, 1705, 1805, 1905 and 2005 include one of bandages and dressings.

Any of the layers of articles 1600, 1700, 1800, 1900 and 2000 may be used or substituted in the other articles 1700, 1800, 1900 and 2000.

FIG. 21 illustrates a wound healing article 2100 having a body 2105 with a three-ply structure according to an embodiment. The body includes a first ply PL61, a second ply PL62 and a third ply PL63. The first ply PL61 may include a first material or fabric 2115. In some embodiments, the first material or fabric 2115 may be a non-adherent material suitable for dressings or bandages. The second ply PL62 may include treated fiber material 2120 (i.e., treated fiber material 1620) treated with an AgCNP2 ingredient. The AgCNP2 ingredient includes silver-modified cerium oxide nanoparticles (AgCNP2) having a predominant 3+ cerium charge and in a range of about 3-35 nanometers (nm) in size and is non-ionizing (i.e., only non-ionizing metallic silver phase). The treated fiber material 2120 may be treated with a mixture including the AgCNP2 and one or more of a polymeric binder, a dispersant, and a stabilizer. The AgCNP2 ingredient is mixed in an amount that is in a range of about 0.01 to 0.1 weight percentage of the mixture.

The third ply PL63 includes a third material or fabric 2112. The third material or fabric 2112 may be the same material or different as the first material or fabric 2115. In some embodiments, the first and third material or fabric 2115 and 2112 may be untreated gauze or 100a % cotton with the second ply PL62 being treated gauze fibers, for example. In other embodiments, the first and third material or fabric 2115 may be N95 Respirator Mask materials with an interior embedded layer corresponding to the second ply PL62 with treated fiber material 2120 (i.e., fiber material 1620).

In some embodiments, a ply may include one or more layers of a fabric or material for a dressing or bandage.

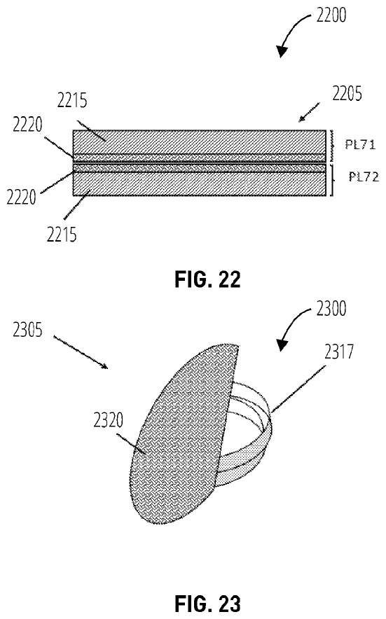

FIG. 22 illustrates a wound healing article 2200 having body 2205 with a two-ply structure according to an embodiment. The body 2205 includes a first ply PL71 and a second ply PL72. The first ply PL71 may include a first material or fabric 2215. The second ply PL72 may include the first material or fabric 2215. A portion of the first ply PL71 and the second ply PL72 includes treated fiber material 2220 treated with an AgCNP2 ingredient, as described above in relation to FIG. 20. The body 2205 includes stacked plies where directly opposing or interior surfaces of the first and second plies PL71 and PL72 are treated fiber material 2220 treated with a mixture including the AgCNP2 and one or more of a polymeric binder, a dispersant, and a stabilizer. The AgCNP2 ingredient is mixed in an amount that is in a range of about 0.01 to 0.1 weight percentage of the mixture.

FIG. 23 illustrates a side view of a wound healing article 2300 with a face mask form factor according to an embodiment. The body 2305 of the wound healing article 2300 may include at least one ply or layer of treated fiber material 2320. The body 2305 may include straps 2317, one on each side of the body 2305, configured to be worn about ears of a wearer. Alternately, the body 2305 may include at least one strap 2317 having one end attached to a first side of the body and a second end attached to a second end of the body so that the at least one strap 2317 may be placed around the back of a head or neck of the wearer. The body 2305 may include two-ply structure shown in FIG. 22 or a three-ply structure shown in FIG. 20, for example.

The wound healing articles may be applied to at least one of the mouth and nose or areas adjacent to the breath stream from at least one of the mouth and nose. The wound healing articles described herein may be used to continually reduce the viral load near the mouth and nose and also prevent bacterial growth (from Streptococcus mutans and Staphylococcus aureus) that are commonly found near a person's nose and mouth.

### Coating Composition for Surfaces

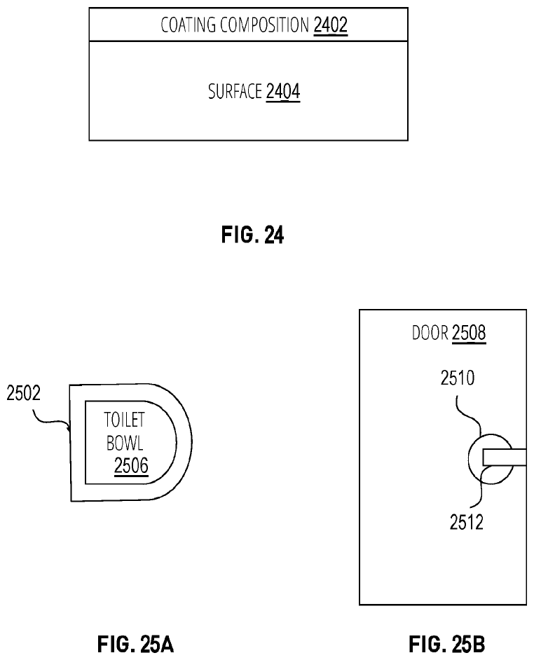

FIG. 24 shows a surface 2402 of an article coated with a coating composition 2404 such as a NanoRAD coating, as described herein. The surface 2402 may be any hard surface such as cabinets, walls, sinks, toilets, countertops, floors, cars, ships, marine surfaces, computing devices, electronic devices, furniture, doorknobs, faucets, hospital beds, night tables, appliances, toys, and more. The surface 2402 may include man-made materials, metal, porcelain, ceramic, cement, wood, engineered wood, and engineered synthetic materials, for example. The surface 2402 may include a soft surface made of fibers, such as fabric, textile, and carpet. The coating composition 2404 may include clearcoat ingredients that are suitable for the particular surface application.

The soft surface may be made of fibers, paper or soft plastics or synthetic ingredients such as used to cover menus.

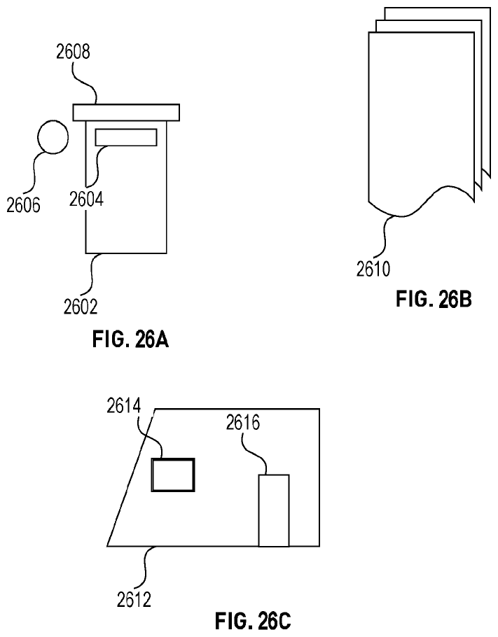

Example articles are shown in FIGS. 25A, 25B and 26A-26C. As should be understood, showing, and describing each and every possible article is prohibitive.

FIG. 25A illustrates a toilet seat 2502 coated with a coating composition, such as a NanoRAD coating, in accordance with one embodiment. The toilet seat 2502 may be mounted on a toilet bowl 2506. The toilet bowl 2506 may be made of porcelain while the toilet seat 2502 may be made of plastic, wood, or synthetic materials. Both the toilet seat 2502 and toilet bowl 2506 may be coated with different coating compositions 2404.

FIG. 25B illustrates a door 2508 with a door handle 2512 affixed to a plate 2510 in accordance with one embodiment. The door 2508 may be coated with a first coating composition 2404, such as a NanoRAD coating, while the door handle 2512 and plate 2510 may be coated with a second coating composition 2404, such as another NanoRAD coating, different from the first coating composition.

FIG. 26A illustrates furniture such as nightstand 2606 and headboard 2608 coated with a coating composition, such as a NanoRAD coating, in accordance with one embodiment. In some embodiments, the headboard 2608 is attached to a bed 2602 having a pillow 2604. The nightstand 2606 and headboard 2608 may be coated with a coating composition 2404. In some embodiments, the nightstand 2606 and headboard 2608 may be made of similar material which is suitable for using a coating composition 2404 of the same type. In other instances, the nightstand 2606 and headboard 2608 may be made of different types of material requiring different NanoRAD coating compositions 2404.

FIG. 26B illustrates fabric 2610 coated with a NanoRAD coating in accordance with one embodiment. The fabric 2610 may include fibers that are configured to be coated with a coating composition 2404. The fabric 2610 may be used for curtains, for example, in a hospital, office, hotel, public location, residence, or building. The fabric 2610 may be used on soft surfaces, such as cushion chairs, sofas, beds, and the like.

The fabric 2610 may be made into a paper product.

FIG. 26C illustrates an interior wall 2612 of a building having a door 2616 and a window 2614 in accordance with one embodiment.

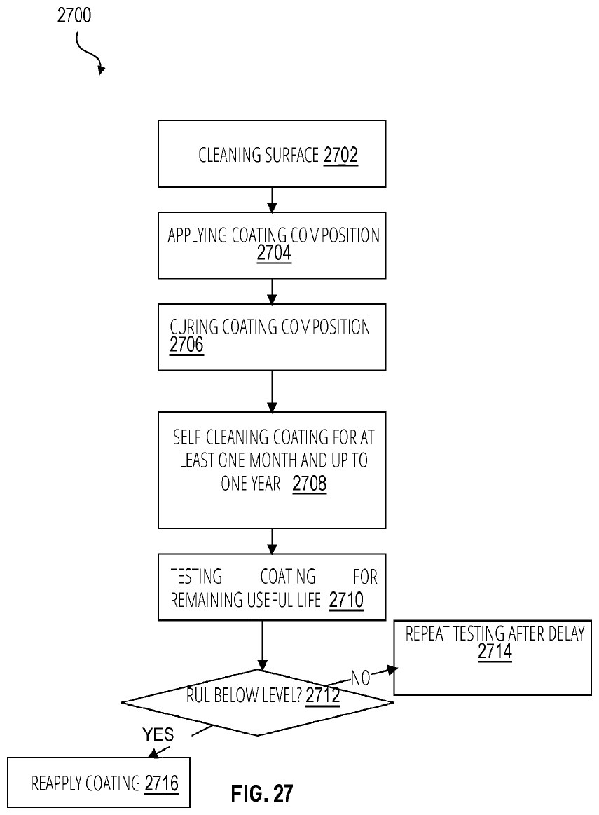

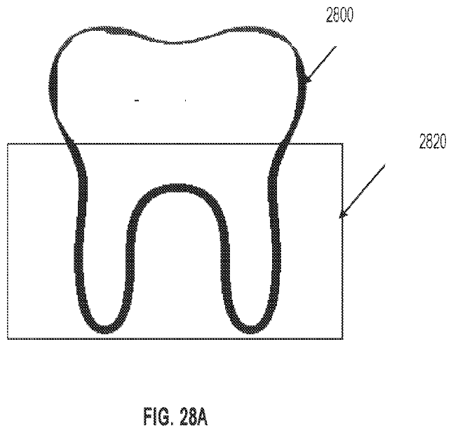

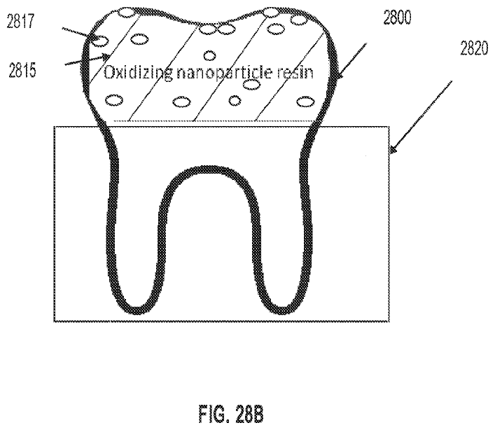

FIG. 27 illustrates a flowchart of a process 2718 for coating a surface in accordance with one embodiment. The process 2718, in block 2702, may include cleaning a subject surface. While it may be recommended to clean the subject surface with a cleaner to remove bacteria and organic material, it may be impossible to remove all bacteria and resistant bacteria. The NanoRAD coating described herein eradicates bacteria and biofilms on the surface after the NanoRAD coating is applied and permanently affixed, for example.

In block 2704, the process 2818 may include applying a NanoRAD coating composition to the subject surface. In block 2706, the process 2718 may include curing or hardening the NanoRAD coating composition to form and affix the NanoRAD coating to the surface of the article. In some embodiments, the curing is performed using a UV light, for example, having a wavelength range of 200 nm to 400 nm. The NanoRAD coating composition 104 may harden or cure in response to an application of UV light in the wavelength range of 200 nm to 400 nm over a period of time. In other embodiments, the NanoRAD coating composition 2404 may be hardened or cured in response to an evaporation of water or application of radiated heat.

In block 2708, the process 2718 may include continuously and autonomously self-cleaning and/or self-disinfecting the NanoRAD coating for at least one month and up to one year. In block 2710, the process 2718 may include testing the NanoRAD coating for remaining useful life (RUL). It should be understood that the NanoRAD coating may be cleaned using commercially available cleaners, such as those applied by spraying and wiping, to remove organic material that may be deposited from interaction with humans or animals. Such cleaning is secondary to the self-cleaning and/or self-disinfecting by the NanoRAD coating to eradicate bacteria, viruses, and biofilms, for example.

In decision block 2712, a determination is made whether the RUL is below a level. If the determination is “NO,” then at block 2714, the process 2718 may include repeat testing after a delay, for example, testing may be repeated daily, weekly, monthly, quarterly, etc. The delay may vary based on the determined RUL level. If the determination is “YES,” then, at block 2716, the process 2718 may include reapplying the coating composition.

The RUL level may be determined using image processing, where the pixels are analyzed based on the appearance of the fluorescing additive. For example, in a region of interest (ROI), if 5% (RUL threshold) of the pixels are not fluorescing, the NanoRAD coating may need to have a new application of the NanoRAD coating over the existing NanoRAD coating. In other examples, the NanoRAD coating in the ROI is greater than the RUL threshold, the entire coating in at least the ROI may be removed so that a new NanoRAD coating can be reapplied. The RUL threshold may be between 5% and 10%. In other embodiments, the RUL threshold may vary based on the article and exposure to frequency of touch by humans or animals.

The coating method may be applied during the manufacturing process of a hard or soft surface article or in the building. In some embodiments, the coating may be sprayed on to the surface. In other embodiments, the coating may be applied in any manner as a paint is applied, such as with a paint brush. During the manufacturing process, the NanoRAD coating composition may be applied during an additive manufacturing process.

The AgCNP2 ingredient can be combined into a composite with many forms of dental resins or sealants that may be applied to the teeth or the back teeth such as, without limitation, premolars, and molars. Premolars may include maxillary first premolar, maxillary second premolar, mandibular first premolar and mandibular second premolar. Molars may include first molars, second molars and third molars. Third molars are known as wisdom teeth which appear generally between 17 and 21 years of age but may be removed earlier by surgery.

Therefore, in some embodiments, multiple applications of a dental resin composite may be needed. The resin or sealant may be applied to a non-permanent tooth and then subsequently, applied to permanent teeth.

There are many dental resins and sealants readily available on the market. In some embodiments, the dental appropriate resin composite may be a light-curable resin composite. The dental resin composite is applied in a therapeutically effective amount to coat the teeth. The amount of AgCNP2 ingredient is mixed or dissolved in the dental resin composite in an amount that is a therapeutically effective amount.

Example resin composites are described in U.S. Pat. No. 4,826,893, entitled “Dental Resin Composition,” to Yamazaki et al., incorporated herein by reference in its entirety.

In some embodiments, acrylic-based polymer resins such as methyl methacrylate-based resin systems that include other monomer polymers and fillers are appropriate types of resin composites.

A methyl methacrylate-based dental resin may include a methyl methacrylate polymer resin (heat cured or self-cured or light cured) such as polymethyl methacrylate, a polymethyl methacrylate curing process that is initiated by tertiary and amine compounds.

The methyl methacrylate-based dental resin may include monomer polymers and fillers where a poly methyl methacrylate (PMMA) powder incorporates a filler such as silica, titania, or zirconia, and includes an initiator such as benzoyl peroxide. The methyl methacrylate-based dental resin may include a liquid component containing methyl methacrylate (MMA) monomer, with a crosslinking agent and inhibitor, where a combination of liquid with powder components initiates polymerization.

The methyl methacrylate-based dental resin may include PMMA powder, methacrylate monomer polymers and fillers such as titania and silica.

Another example resin composite is described in Published Application WO/201701886, entitled “Photopolymerisable Resin Composite and Use Thereof,” to DeOliveira, et al., incorporated herein by reference in its entirety. For example, the dental resin comprises a photopolymerisable resin composite with a higher filler particle content and a resin matrix of dimethacrylate monomers which are polymerized by free radical reaction initiated by the synergy of photoinitiator systems based on camphorquinone and (2,4,6-trimethylbenzoyl)diphenylphosphine oxide with monomer systems such as Bisphenol A Glycyl Dimethacrylate (Bis-GMA), Urethane Dimethacrylate (UDMA) Hydroxyethyl Methacrylate Phosphate (HEMA-P), glycerol dimethacrylate dihydrogen phosphate and mixtures of similar monomers.

A UDMA-based dental resin may include a photopolymerisable resin composite such as UDMA with a higher filler particle content and a resin matrix of dimethacrylate monomers, which are polymerized by free radical reaction initiated by the synergy of photoinitiator systems based on camphorquinone and (2,4,6-trimethylbenzoyl)diphenylphosphine oxide.

In some embodiments, Urethane Dimethacrylate-based dental resins (that can include other monomers and fillers) may be used, as described in A. Szczesio-Wlodarczyk et al., “An Evaluation of the Properties of Urethane Dimethacrylate-Based Dental Resins,” www.mdpi.com/1996-1944/4/1/2727/htm, incorporated herein by reference in its entirety.

A urethane dimethacrylate-based dental resin is light curable and may include UMDA combined with ethoxylated bisphenol-A dimethacrylate, for example.

Nanoparticles have been known to improve impact strength of dental acrylic resins. [Shcherbakov et al., entitled “CeO2 Nanoparticles-Containing Polymers for Biomedical Applications: A Review, 17 Mar. 2021, Polymers 2021, 3, 924, www.doi.org/10.3390/polym3060924.]

### Treatment/Prevention

The method of preventing dental caries will be described in relation to FIGS. 28A, 28B and 29, 30 and 31. The method of preventing dental caries may include forming a dental resin composite with AgCNP2 in the amount of about 0.01-0.1 wt. %. The method may include cleaning a subject's teeth to remove surface contaminants. In some embodiments, surface contaminants may include plaque. Surface contaminants may include food particles, which may be embedded in the depressions or grooves naturally occurring or worn in the surface of a tooth or between surfaces of adjacent teeth.

FIG. 28A illustrates a subject tooth 2800 in a clean state. The tooth 2800 is represented in the gums 2820 of a subject. FIG. 28B illustrates a subject tooth 2800 of FIG. 28A with a coating 2815 of dental resin composite including AgCNP2 2817, coated on the tooth 2800. Specifically, the dental resin composite including AgCNP2 may be coated on the enamel of the tooth which is the outer surface of the tooth above the gums.

After the tooth surface (i.e., enamel) has been cleaned, the dental resin composite including AgCNP2 may be coated on the enamel of the tooth 2800. In some embodiments, the coating 2815 of the composite is cured. For example, the dental resin composite may be light cured. For example, an ultraviolet light (UV) source may be used. The curing process hardens the dental resin composite including AgCNP2 on the tooth's surface.

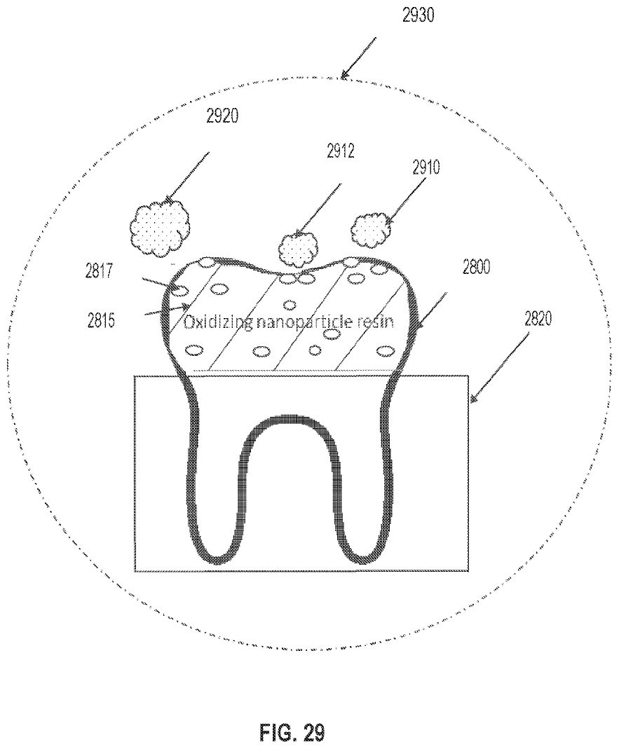

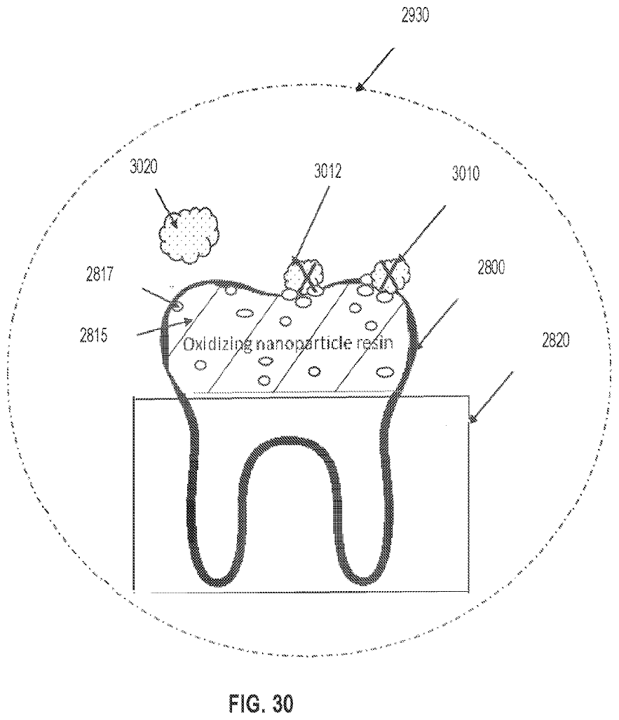

FIG. 29 illustrates a coated subject tooth 2800 of FIG. 28B in the mouth 2930 with bacteria 2910, 2912 and 2920. FIG. 30 illustrates a coated subject tooth 2800 of FIG. 29 releasing directed hydrogen peroxide (H₂O₂) to degrade or destroy caries-causing bacteria, denoted by 3010 and 3012. Bacteria that cause dental caries may include bacteria that feed on sugar, including carbohydrates that are left in the mouth. These bacteria may include, without limitation, Streptococcus mutans, such as Streptococcus sobrinus, and Lactobacilli acidophilus. The inventor has determined covering the tooth with cured dental resin composite with the silver-modified cerium oxide nanoparticles(AgCNP2) 2817, described herein, causes the autonomous release, from the AgCNP2, hydrogen peroxide directed against bacteria in an oral cavity to prevent local acidification of the tooth and prevents further decay. The release of hydrogen peroxide is a non-indiscriminate release in the body and generally limited to release for destroying bacteria having a propensity to colonize on teeth.

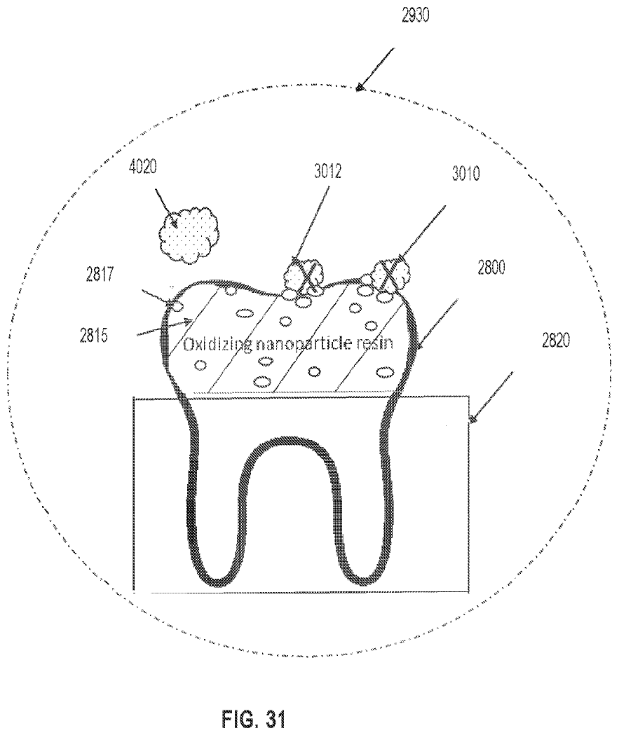

FIG. 31 illustrates the coated subject tooth 2800 of FIG. 30 with the bacteria 3010 and 3012 degraded or destroyed. The bacteria 4020 may be a different type of bacteria that does not have a propensity to colonize on teeth. Therefore, the AgCNP2 2817, as described herein, may not release hydrogen peroxide to destroy bacteria that do not make sustained contact with a treated tooth 4020.

### Applications

The embodiments herein incorporate by reference in full U.S. application Ser. No. 17/973,640, titled “NANOPARTICLES TO PROMOTE WOUND HEALING AND ANTIMICROBIAL INFECTION CONTROL,” filed Oct. 26, 2022.

The wound healing composition for the epithelial tissue including skin or eye tissue to target the oxidizing response need to kill viruses and bacteria to the virus and bacteria. Additionally, wound healing composition may include an epithelial tissue healing agent and AgCNP2, which acts as an antioxidant in the presence of healthy cells, promoting lower inflammation and cell growth. This allows for quicker closure of the wound while assuring that any trapped bacteria will not lead to an infection. The nature of the wound healing composition is that it works against a broad range of viruses and bacteria.

The epithelial tissue healing agent may be selected from a group consisting of preadipocyte modulator and an adipocyte modulator and contain in a pharmaceutically acceptable composition for subcutaneous administration, as described in U.S. Pat. No. 7,638,484, incorporated herein by reference in its entirety.

The epithelial tissue healing agent may include a therapeutically effective amount of a viral vector comprising a polynucleotide coding for an adipokine, as described in U.S. Pat. No. 7,638,484.

The skin cells colonizing the damaged skin or skin wound may be of any cell type which is involved in the wound healing process, such as keratinocytes, fibroblasts, adipocytes or preadipocytes. The cells can be transformed by a polynucleotide encoding an adipokine as defined hereinbefore. Alternatively, the cells can be transformed by a polynucleotide encoding a polypeptide capable of an adipokine activity, such as the polynucleotide encoding adipsin/complement D activity described in U.S. Pat. No. 5,223,425, incorporated by reference.

The suitable polynucleotide can be introduced into cells by any one of a variety of known methods within the art. Such methods are generally described in Sambrook et al., (1989, 1992), Ausubel et al., (1989), Chang et al., (1995), Vega et al., (1995), Rodriguez and Denhardt (1988) and Gilboa et al., (1986), and include, for example, stable or transient transfection, lipofection, electroporation and infection with recombinant viral vectors. U.S. Pat. No. 4,866,042 discloses a list of vectors involving the central nervous system, and U.S. Pat. Nos. 5,464,764 and 5,487,992 describe positive-negative selection methods for inducing homologous recombination, all of which patents are incorporated herein by reference.

The wound healing composition may include a tissue adhesive or glue and an aqueous solution of silver-modified cerium oxide nanoparticles (AgCNP2) in a range of about 3-35 nm in size and mixed in an amount that is in a range of about 0.01 to 0.1 weight percentage of a mixture having the tissue adhesive and the AgCNP2.

The tissue adhesive or glue formulation may include the components for delivery and administration to a surgical incision or wound.

In certain embodiments, the tissue glue may include a fibrin glue. Fibrin glue as a surgical adhesive is well known in the art. The tissue glue may include hydrogels comprising, for example, but not limited to, polyethylene glycol (PEG), fibrin, dextrans, including dextrans suitable for chemical crosslinking and/or photo-crosslinking, albumin, polyacrylamide, polyglycolic acid (PGA), polyvinyl chloride, polyvinyl alcohol, poly(n-vinyl-2-pyrollidone), poly(2-hydroxy ethyl methacrylate), hydrophilic polyurethanes, acrylic derivatives, pluronics, such as polypropylene oxide and polyethylene oxide copolymer (POC), or the like.

The use of fibrin glue as a skin adhesive for closing surgical incisions is well known in the art. The glue compositions may also include additional components such as liposomes, for example. Example, fibrin glue compositions are disclosed in U.S. Pat. No. 5,290,552, which is incorporated by reference.

In certain embodiments, the adhesive or glue may comprise non-degradable materials, for example, but not limited to, expanded polytetrafluoroethylene (ePTFE), polytetrafluoroethylene (PTFE), polyethyleneterephthalate (PET), polyurethane, polyethylene, polycarbonate, polystyrene, silicone, and the like, or selectively degradable materials, such as poly (lactic-co-glycolic acid; PLGA), polylactic acid (PLA), or PGA.

In certain embodiments, the surgical glue or adhesive may be a photo-activated glue, acrylate-based adhesives, and the like.

Example synthetic hydrogels may include polyphosphazenes, poly (vinyl alcohol)(PVA), and an interpenetrating and semi-interpenetrating hydrogels (e.g., PEO, and PEO-PEO-dimethylacrylate blends).

Example tissue adhesives may be a single component adhesive or multi-component adhesive. Further suitable adhesives include synthetic adhesives and/or natural adhesives. Suitable biocompatible adhesives for use in the wound healing composition include commercially available surgical adhesives, such as cyanoacrylate (such as 2-octyl cyanoacrylate, Dermabond™) and fibrin glue (such as Tissucol®).

There are many tissue glues, surgical glues, or tissue adhesives readily available on the market. The healing wound composition is applied in a therapeutically effective amount to the wound to close the wound. The amount of the AgCNP2 ingredient is mixed or dissolved in the wound healing composition in an amount that is a therapeutically effective amount with a surgical adhesive or glue.

The wound healing composition may include a solid composition or a liquid composition, by way of non-limiting example. For a solid composition of a pharmaceutically acceptable composition, conventional nontoxic solid carriers include, for example, pharmaceutical grades of mannitol, starch, magnesium stearate, talc, lactose, glucose, sucrose, sodium saccharin, magnesium carbonate, cellulose, and the like. For liquid pharmaceutically acceptable compositions, the pharmaceutically acceptable composition may be prepared by dissolving, dispersing, mixing, etc., an active compound, as described herein, and optional pharmaceutical adjuvants in an excipient such as, for example, saline, water, aqueous dextrose, ethanol, glycerol, and the like, to thereby form a solution or suspension. The pharmaceutical acceptable composition may contain minor amounts of nontoxic auxiliary substances such as wetting or emulsifying agents, pH buffering agents and the like, for example, sorbitan mono-laurate, sodium acetate, triethanolamine oleate, triethanolamine acetate, etc. Specifically, the wound healing composition includes an amount of the AgCNP2 ingredient mixed or dissolved in the wound healing composition includes about 0.01 to 0.1 weight percentage (wt %).

Methods of preparing dosage forms of the pharmaceutical acceptable composition are known, or will be apparent, to those skilled in this art. For oral administration, the pharmaceutical acceptable composition will generally take the form of a tablet or capsule, or may be an aqueous or nonaqueous solution, suspension, or syrup. Tablets and capsules for oral use will generally include one or more commonly used carriers such as lactose and corn starch. Lubricating agents, such as magnesium stearate, are also typically added. When liquid suspensions are used, the active agent may be combined with emulsifying and suspending agents. If desired, flavoring, coloring and/or sweetening agents may be added as well. Other optional components for incorporation into an oral formulation of the pharmaceutical acceptable composition herein include, but are not limited to, preservatives, suspending agents, thickening agents, and the like. One skilled in this art may further formulate the pharmaceutical acceptable composition in an appropriate manner, and in accordance with accepted practices, such as those disclosed in Remington's Pharmaceutical Sciences, Gennaro, Ed., Mack Publishing Co., Easton, Pa. 1990.

The embodiments herein incorporate by reference in full U.S. application Ser. No. 17/973,769, titled “THERAPEUTIC ARTICLE OF MANUFACTURE WITH NANOPARTICLES TO PROMOTE WOUND HEALING AND/OR ANTIMICROBIAL INFECTION CONTROL,” filed Oct. 26, 2022.

The embodiments herein incorporate by reference in full U.S. application Ser. No. 18/090,693, titled “CONTINUOUS SELF-DISINFECTING AND PATHOGEN ERADICATING COATING, ARTICLE OF MANUFACTURE WITH THE COATING AND METHOD OF APPLICATION,” filed Dec. 29, 2022.

The embodiments herein incorporate by reference in full U.S. application Ser. No. 17/973,720, titled “METAL-MODIFIED NANOPARTICLE ENABLED DENTAL RESINS FOR PREVENTION OF DENTAL CARIES,” filed Oct. 26, 2022.

The embodiments herein incorporate by reference in full U.S. application Ser. No. 17/973,822, titled “ELECTRONIC DEVICE WITH SELF-DISINFECTING TOUCH SCREEN AND METHOD OF MANUFACTURE,” filed Oct. 26, 2022.

In one embodiment, a method for manufacturing silver-modified cerium oxide nanoparticles (AgCNP2) is provided. The method includes a closed system process that causes ionized Ag to crystallize onto cerium oxide nanoparticles as a non-ionized metallic silver phase with essentially no waste by product remaining or requiring removal. The method, after mixing the solution to be aged, creates a closed system containing the mixed solution; and uses at least on accelerant to cause ionized Ag to crystallize onto cerium oxide nanoparticles as a non-ionized metallic silver phase with essentially no waste by product remaining or requiring removal.

The process includes using a process with at least one accelerant that speeds up the peroxy ligand conversion of AgCNP2 having a predominant 3+ cerium charge, the at least one accelerant that accelerates evolution of all, to 1 ppm or less of the limit of detection, ionized Ag to crystallize onto cerium oxide nanoparticles as a non-ionized metallic silver phase is selected from the group consisting of: low heat of 90°-115 °F during an aging process during which peroxy ligand conversion takes place; food grade or wholly un-stabilized hydrogen peroxide; and a form factor ratio of a vessel in which the AgCNP2 age during the ageing process.

In one embodiment, a wound healing composition is provided that includes a tissue adhesive; and an aqueous solution that includes silver-modified cerium oxide nanoparticles (AgCNP2) having a predominant 3+ surface charge and in a range of about 3-35 nanometers (nm) in size and mixed in an amount that is in a range of about 0.01 to 0.1 weight percentage of a mixture having the tissue adhesive and aqueous solution that includes the AgCNP2 wherein the AgCNP2 being produced using a method described herein that uses at least one accelerant in a closed system.

In one embodiment, a therapeutic article of manufacture is provided that includes a body having fibers treated with a mixture including an aqueous solution that includes silver-modified cerium oxide nanoparticles (AgCNP2) having a predominant 3+ cerium charge and in a range of about 3-35 nanometers (nm) in size and one or more of a polymeric binder, a dispersant, and a stabilizer, the AgCNP2 being mixed in an amount that is in a range of about 0.01 to 0.1 weight percentage of the mixture wherein the AgCNP2 being produced using a method described herein that uses at least one accelerant in a closed system. The method employs at least one accelerant to speed up peroxy ligand conversion of cerium oxide nanoparticles (CNP) having a predominant 3+ cerium charge and accelerate evolution of all, to 1 ppm or less of the limit of detection, ionized Ag to crystallize onto cerium oxide nanoparticles as a non-ionized metallic silver phase to form the AgCNP2.

In one embodiment, a touch screen display is provided that includes a touch screen layer stack having a plurality of layers that includes a top surface layer; and a coating composition coating the top surface layer, the coating composition comprising silver-modified cerium oxide nanoparticles (AgCNP2) having a predominantly 3+ cerium charge and in a range of about 3-30 nm in size and in an amount that is in a range of about 1 weight percentage of a mixture having a binder and the aqueous solution with the AgCNP2 wherein the aqueous solution with the AgCNP2 being produced using a method described herein that uses at least one accelerant adapted for use in a closed system. The method employs at least one accelerant to speed up peroxy ligand conversion of cerium oxide nanoparticles (CNP) having a predominant 3+ cerium charge and accelerate evolution of all, to 1 ppm or less of the limit of detection, ionized Ag to crystallize onto cerium oxide nanoparticles as a non-ionized metallic silver phase to form the AgCNP2.

In one embodiment, a long-lasting and mechanically stable coating composition is provided that includes an aqueous solution that includes silver-modified cerium oxide nanoparticles (AgCNP2) ingredient selected from a group consisting of predominantly 3+ cerium charge, wherein the AgCNP2 being produced using a method described herein that uses at least one accelerant; and a paint where the AgCNP2 ingredient has a weight percent loading less than about 1 weight % in a mixture with the paint that is a durable adhesive coating once cured. The method employs at least one accelerant to speed up peroxy ligand conversion of cerium oxide nanoparticles (CNP) having a predominant 3+ cerium charge and accelerate evolution of all, to 1 ppm or less of the limit of detection, ionized Ag to crystallize onto cerium oxide nanoparticles as a non-ionized metallic silver phase to form the AgCNP2.

In one embodiment, a wound healing composition is provided that includes an epithelial tissue healing agent; and an aqueous solution that includes silver-modified cerium oxide nanoparticles (AgCNP2) having a predominant 3+ cerium charge and in a range of about 3-35 nm in size and mixed in an amount that is in a range of about 0.01 to 0.1 weight percentage of a mixture having the epithelial tissue healing agent and the aqueous solution with the AgCNP2 and wherein the AgCNP2 being produced using a method described herein that uses at least one accelerant adapted for use in a closed system. The method employs at least one accelerant to speed up peroxy ligand conversion of cerium oxide nanoparticles (CNP) having a predominant 3+ cerium charge and accelerate evolution of all, to 1 ppm or less of the limit of detection, ionized Ag to crystallize onto cerium oxide nanoparticles as a non-ionized metallic silver phase to form the AgCNP2.

In one embodiment, a dental resin composition is provided that includes a dental resin; and an aqueous solution with silver-modified cerium oxide nanoparticles (AgCNP2) having a predominantly 3+ cerium charge and in a range of about 3-25 nm in size and mixed in an amount that is in a range of about 0.01 to 0.1 weight percentage of a mixture having the dental resin and the aqueous solution with the AgCNP2, and the AgCNP2 effectuate release directed hydrogen peroxide (H₂O₂) in an oral cavity that is then used against bacteria in the oral cavity to prevent local acidification of a tooth on which a therapeutically effect amount of the mixture is applied and cured and wherein the AgCNP2 being produced using a method described herein that uses at least one accelerant adapted for use in a closed system. The method employs at least one accelerant to speed up peroxy ligand conversion of cerium oxide nanoparticles (CNP) having a predominant 3+ cerium charge and accelerate evolution of all, to 1 ppm or less of the limit of detection, ionized Ag to crystallize onto cerium oxide nanoparticles as a non-ionized metallic silver phase to form the AgCNP2.

In one embodiment, a method for manufacturing silver-modified cerium oxide nanoparticles (AgCNP2) is provided that includes using a process with at least one accelerant adapted for use in a closed system that speeds up the peroxy ligand conversion of AgCNP2 having a predominant 3+ cerium charge, the at least one accelerant accelerates evolution of all, to 1 ppm or less of the limit of detection, ionized Ag to crystallize onto cerium oxide nanoparticles as a non-ionized metallic silver phase with no waste material byproduct that is greater than 1 ppm of ionized silver.

In one embodiment, a method for manufacturing silver-modified cerium oxide nanoparticles (AgCNP2) is provided that includes mixing in a single vessel cerium nitrate hexahydrate and silver nitrate to form a solution; applying an accelerant to the solution; and forming from the solution the AgCNP2 having a predominant 3+ cerium charge, the accelerant accelerates evolution of all, to 1 ppm or less of the limit of detection, ionized Ag to crystallize onto cerium oxide nanoparticles as a non-ionized metallic silver phase without any waste material byproduct that is greater than 1 ppm of ionized silver.

In one embodiment, the accelerant is selected from the group consisting of: applying low heat of 90°-115 °F during an aging process within a closed system during which peroxy ligand conversion takes place; and adding a food grade hydrogen peroxide or a wholly un-stabilized hydrogen peroxide to a mixture prior to the aging process in the closed system.

In one embodiment, a process for manufacturing silver-modified cerium oxide nanoparticles (AgCNP2) is provided that includes forming in a single vessel an initial solution between 250 gallons to 275 gallons that comprises cerium nitrate hexahydrate, wholly un-stabilized hydrogen peroxide and silver nitrate; applying heat to the initial solution; and ageing the solution which forms the AgCNP2 having a predominant 3+ cerium charge, and evolves all, to 1 ppm or less of the limit of detection, ionized Ag to crystallize onto cerium oxide nanoparticles as a non-ionized metallic silver phase without any waste material byproduct that is greater than 1 ppm of ionized silver within the vessel in 3 to 5 weeks.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

Embodiments are described herein with reference to the attached FIGURES wherein like reference numerals are used throughout the FIGURES to designate similar or equivalent elements. In some instances, FIGURES are not drawn to scale and they are provided merely to illustrate aspects disclosed herein.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Therefore, the breadth and scope of the subject matter provided herein should not be limited by any of the above explicitly described embodiments. Rather, the scope of the embodiments should be defined in accordance with the following claims and their equivalents.

What is claimed is:

1. A method for manufacturing silver-modified cerium oxide nanoparticles (AgCNP2), comprising:
ageing in a closed system un-aged cerium oxide nanoparticles in a solution that includes silver nitrate and uses at least one accelerant, the at least one accelerant speeds up peroxy ligand conversion of cerium oxide nanoparticles (CNP) having a predominant 3+ cerium charge and accelerates evolution of all, to 1 ppm or less of the limit of detection, ionized Ag to crystallize onto cerium oxide nanoparticles as a non-ionized metallic silver phase to form the AgCNP2, the at least one accelerant is selected from the group consisting of:
a) low heat of 90°-115 °F applied to the closed system to heat the solution only after crash-out of the solution that is without an ingredient that incudes wholly un-stabilized hydrogen peroxide;
b) wholly un-stabilized hydrogen peroxide mixed in the solution prior to aging in the closed system;
c) low heat of 90°-115 °F applied to the closed system to heat the solution that includes wholly un-stabilized hydrogen peroxide; and
d) a form factor (FF) ratio of a vessel of the closed system where the ageing takes place.

2. The method for manufacturing the AgCNP2 of claim 1, wherein the at least one accelerant includes wholly un-stabilized hydrogen peroxide; and
further comprising:
mixing, in a single vessel, water, cerium nitrate hexahydrate, and the silver nitrate to form the solution;
adding the wholly un-stabilized hydrogen peroxide to the solution in the single vessel;
closing the vessel to form a closed system with the solution within the single vessel; and
during the aging, forming from the solution the AgCNP2 having the predominant 3+ cerium charge and in a range of about 3-35 nanometers (nm) in size, the accelerant accelerates evolution of all, to 1 ppm or less of the limit of detection, ionized Ag to crystallize onto cerium oxide nanoparticles as a non-ionized stable metallic silver phase without any waste material byproduct that is greater than 1 ppm of ionized silver.

3. The method of manufacturing the AgCNP2 of claim 2, wherein the at least one accelerant further includes the low heat of 90°-115 °F applied to the closed system to heat the solution.

4. The method of manufacturing the AgCNP2 of claim 4, wherein:
the vessel holds 275 gallons; and
the ageing is completed in about three weeks for 1× concentration of ingredients in the solution of 250 gallons; or
the ageing is completed in about five weeks for 4× concentration of ingredients in the solution of the 250 gallons.

5. The method of manufacturing the AgCNP2 of claim 1, wherein the at least one accelerant includes the FF ratio wherein the FF ratio is W1/HV>1 such that the vessel has a height and an inner width (W1) where a height of a volume (HV) of solution is less than the W1 so that the FF ratio is W1/HV>1.

6. The method of manufacturing the AgCNP2 of claim 1, the at least one accelerant includes the low heat of 90°-115 °F applied to the closed system to heat the solution only after crash-out of the solution that is without the ingredient that includes the wholly un-stabilized hydrogen peroxide.

7. The method of manufacturing the AgCNP2 of claim 1, wherein the at least one accelerant includes low heat applied to the solution speeds up ageing by a factor of 3-6.

8. A formulation comprising:
an aqueous solution including silver-modified cerium oxide nanoparticles (AgCNP2) having a predominant 3+ surface charge and in a range of about 3-35 nanometers (nm) in size, wherein the aqueous solution including the AgCNP2 produced using a method of claim 1.

9. The formulation of claim 8, wherein the aqueous solution includes an accelerant that includes wholly un-stabilized hydrogen peroxide mixed in the aqueous solution prior to aging in the closed system.

10. The formulation of claim 9, wherein the at least one accelerant includes low heat applied to the aqueous solution with the AgCNP2 speeds up ageing by a factor of 3-6.

11. The formulation of claim 8, further comprising a first composition selected from a group consisting of:
a tissue adhesive;
a paint that is a durable adhesive coating once cured on a surface;
an epithelial tissue healing agent;
a dental resin;
a mixture of one or more of a polymeric binder, a dispersant, and a stabilizer; and
a binder for coating a top surface layer of a touch screen display.

12. The formulation of claim 11, wherein the first composition comprises:
a tissue adhesive; and
wherein the AgCNP2 is mixed in an amount that is in a range of about 0.01 to 0.1 weight percentage of the mixture having the tissue adhesive and the aqueous solution with the AgCNP2.

13. The formulation of claim 11, wherein the first composition comprises:
a paint; and
wherein the AgCNP2 has a weight percent loading less than about 1 weight % with the aqueous solution with the AgCNP2 in the mixture and the paint that is a durable adhesive coating once cured.

14. The formulation of claim 11, wherein the first composition comprises:
an epithelial tissue healing agent; and
wherein the AgCNP2 being mixed in an amount that is in a range of about 0.01 to 0.1 weight percentage of the mixture having the epithelial tissue healing agent and the aqueous solution with the AgCNP2.

15. The formulation of claim 11, wherein the first composition comprises:
a dental resin; and
wherein the AgCNP2 being mixed in an amount that is in a range of about 0.01 to 0.1 weight percentage of a mixture having the dental resin and the aqueous solution with the AgCNP2, and the AgCNP2 effectuates release directed hydrogen peroxide (H₂O₂) in an oral cavity that is then used against bacteria in the oral cavity to prevent local acidification of a tooth on which a therapeutically effect amount of the mixture is applied and cured.

16. The formulation of claim 15, wherein the dental resin is a light-curable resin composite.

17. The formulation of claim 8, further comprising: a first composition, the first compositing comprises:
one or more of a polymeric binder, a dispersant, and a stabilizer;
where the AgCNP2 being mixed in an amount that is in a range of about 0.01 to 0.1 weight percentage of the mixture having the one or more of the polymeric binder, the dispersant and the stabilizer and the aqueous solution with the AgCNP2.

18. A therapeutic article of manufacture comprising a body having fibers treated with the formulation of claim 17.

19. A touch screen surface comprising:
a touch screen layer stack having a plurality of layers that includes a top surface layer; and
a coating composition coating the top surface layer, the coating composition comprising an aqueous solution with silver-modified cerium oxide nanoparticles (AgCNP2) having a predominantly 3+ cerium charge and in a range of about 3-30 nm in size and in an amount that is in a range of about 1 weight percentage of a mixture having a binder and the aqueous solution with the AgCNP2 wherein the aqueous solution with the AgCNP2 produced using a method of claim 1, and the binder includes one of alkali silicate, borate, phosphate and polyvinyl pyrrolidone.

20. The touch screen surface to claim 19, wherein the touch screen layer stack comprises one of a liquid crystal display (LCD), a light emitting diode (LED) display, an organic light-emitting diode (OLED) display, a quantum dot display (QLED), and a liquid crystal on silicon (LCoS) display.

21. The touch screen surface according to claim 19, wherein the binder includes alkali silicate that comprises SiO₂ and Alk₂O, wherein Alk comprises Li, Na or K at a ratio from about 0.05:1 to about 20.0:1 SiO₂:Alk₂O.

22. The touch screen surface according to claim 19, wherein the touch screen layer stack includes resistive or capacitive elements below the top surface layer, the resistive or capacitive elements are made of one of indium tin oxide (ITO) and antimony tin oxide (ATO).
